(19) United States
(12) Patent Application Publication
(10) Pub. No.: US 2010/0203284 A1
(43) Pub. Date: Aug. 12, 2010

(54) SEALING MATERIAL FOR HONEYCOMB STRUCTURE, HONEYCOMB STRUCTURE, AND METHOD FOR MANUFACTURING HONEYCOMB STRUCTURE

(75) Inventor: Masanori KANAI, Ibi-gun (JP)

Correspondence Address: Ditthavong Mori & Steiner, P.C., 918 Prince Street, Alexandria, VA, 22314, US

(73) Assignee: IBIDEN CO., LTD, Ogaki-shi (JP)

(21) Appl. No.: 12/699,812

(22) Filed: Feb. 3, 2010

(30) Foreign Application Priority Data
Feb. 10, 2009 (JP) PCT/JP2009/052233

(51) Int. Cl. B32B 3/12; C09D 1/00; B05D 3/02; C04B 33/34

(52) U.S. Cl. 428/116; 106/286.6; 106/287.24; 106/286.5; 427/372.2; 156/89.22

(57) ABSTRACT

A sealing material for a honeycomb structure includes inorganic fibers, an oxide sol, inorganic particles, and a metal-containing material. The inorganic fibers include a biosoluble inorganic compound. The metal-containing material contains at least one of Mg, Ca, and Sr. The sealing material is acidic.

### CROSS-REFERENCE TO RELATED APPLICATIONS

The present application claims priority under 35 U.S.C. §119 to PCT/JP2009/052233 filed on Feb. 10, 2009, the contents of which are incorporated herein by reference in their entirety.

### BACKGROUND OF THE INVENTION

1. Field of the Invention

The present invention relates to a sealing material for a honeycomb structure, a honeycomb structure, and a method for manufacturing a honeycomb structure.

2. Discussion of the Background

Inorganic fibers have been used as materials for various constituent members in a honeycomb structure used as a filter for removing particulates and the like from exhaust gases discharged from an internal combustion engine such as a diesel engine or as a catalyst supporting carrier for converting toxic components such as HC (hydrocarbon) and CO (carbon monoxide) from exhaust gases, or in an exhaust gas purification apparatus using the honeycomb structure.

Specifically, there have been used sealing material containing inorganic fibers, such as a sealing material (adhesive) for combining a plurality of honeycomb fired bodies to form a ceramic block and a sealing material (also referred to as peripheral sealing material or peripheral coating material) to be applied on the periphery of the ceramic block.

In the case where such inorganic fibers are taken into human body, especially in the lung, and remain there for a long time, the inorganic fibers might be harmful to human body. Therefore, it is desired that the inorganic fibers used in the sealing material are highly safe for human body.

WO05/110578A1 has disclosed a sealing material containing, as inorganic fibers, at least one compound selected from the group consisting of an alkali metal compound, an alkaline earth metal compound and a boron compound.

The inorganic fibers containing the compound described in WO05/110578A1 are so-called biosoluble fibers. The biosoluble fibers are soluble in physiological saline solution. Therefore, if taken into human body, the biosoluble fibers are dissolved and discharged out of the body, and this is why they are considered to be highly safe for human body.

The contents of WO05/110578A1 are incorporated herein by reference in their entirety.

### SUMMARY OF THE INVENTION

According to one aspect of the present invention, a sealing material for a honeycomb structure includes inorganic fibers, an oxide sol, inorganic particles, and a metal-containing material. The inorganic fibers include a biosoluble inorganic compound. The metal-containing material contains at least one of Mg, Ca, and Sr. The sealing material is acidic.

According to another aspect of the present invention, a honeycomb structure includes a ceramic block and a peripheral sealing material layer. The ceramic block includes a honeycomb fired body in which a large number of cells are longitudinally placed in parallel with one another with a cell wall interposed therebetween. The peripheral sealing material layer is formed on a peripheral surface of the ceramic block. The peripheral sealing material layer is formed by solidifying a sealing material for a honeycomb structure. The sealing material for a honeycomb structure includes inorganic fibers, an oxide sol, inorganic particles, and a metal-containing material. The inorganic fibers include a biosoluble inorganic compound. The metal-containing material contains at least one of Mg, Ca, and Sr. The sealing material is acidic.

According to another aspect of the present invention, a method is for manufacturing a honeycomb structure. The honeycomb structure includes a ceramic block and a peripheral sealing material layer. The ceramic block includes a honeycomb fired body in which a large number of cells are longitudinally placed in parallel with one another with a cell wall interposed therebetween. The peripheral sealing material layer is formed on a peripheral surface of the ceramic block. The method includes preparing a sealing material for a honeycomb structure. The sealing material includes inorganic fibers, an oxide sol, inorganic particles, and a metal-containing material. The inorganic fibers include a biosoluble inorganic compound. The metal-containing material contains at least one of Mg, Ca, and Sr. The sealing material is acidic. The peripheral sealing material layer is formed by forming a peripheral sealing material paste layer including the sealing material for a honeycomb structure on a peripheral surface of the ceramic block. The peripheral sealing material paste layer is solidified.

### BRIEF DESCRIPTION OF THE DRAWINGS

Amore complete appreciation of the invention and many of the attendant advantages thereof will be readily obtained as the same becomes better understood by reference to the following detailed description when considered in connection with the accompanying drawings, wherein:

FIG. 1 is a perspective view that schematically shows one example of a honeycomb structure according to an embodiment of the present invention;

FIG. 2A is a perspective view that schematically shows one example of a honeycomb fired body that constitutes the honeycomb structure according to an embodiment of the present invention;

FIG. 2B is an A-A line cross-sectional view of the honeycomb fired body shown in FIG. 2A;

FIG. 3 is a perspective view that schematically shows a method for manufacturing samples for evaluation according to Examples and Comparative Examples;

FIG. 4 is a side view that schematically shows a method for measuring the breaking strength of a peripheral sealing material layer for evaluation according to Examples and Comparative Examples;

FIG. 5 is a graph that shows relations between the calcium content in a sealing material for a honeycomb structure and breaking strength relating to the sealing materials for a honeycomb structures prepared in Examples 1 to 10 and Comparative Example 1; and

FIG. 6 is a perspective view that schematically shows one of other examples of the honeycomb structure according to an embodiment of the present invention.

### DESCRIPTION OF THE EMBODIMENTS

The sealing material disclosed in WO05/110578A1 is prepared as a paste-like mixture by mixing an inorganic binder, an organic binder, inorganic particles, water, and the like in addition to the foregoing inorganic fibers. A predetermined sealing material layer (peripheral sealing material layer or adhesive layer) can be formed by applying the sealing material on a ceramic block or a honeycomb fired body.

However, when a sealing material prepared using the biosoluble fibers as inorganic fibers and an oxide sol as an inorganic binder is stored, aggregation or gelation occurs in the paste-like sealing material along with the lapse of time. As a result, the viscosity of the sealing material increases, thereby reducing the flowability.

When a phenomenon such as aggregation or gelation occurs in the sealing material, application of the sealing material to the ceramic block or the like problematically becomes difficult, which has negative effects on the processability.

Moreover, gelation of the sealing material makes it difficult to uniformly apply the sealing material on the ceramic block and the like. As a result, variations tend to occur in the thickness of the applied sealing material, which causes variations in the final strength of the peripheral sealing material layer and the like.

The present inventor has studied the causes of the aggregation or gelation of the sealing material. As a result, he has found that, as the pH value of the sealing material paste increases, gelation of the sealing material becomes more likely to occur due to gelation of the inorganic particles and/or the oxide gel contained in the sealing material.

Although detailed mechanisms of the gelation of the sealing material have not been known, the mechanisms may be as follows.

That is, normally, electrical double layers are formed on the surfaces of the inorganic particles and the oxide sol (oxide in the oxide sol) contained in the sealing material. The electrical double layers are thought to allow the inorganic particles and the oxide sol (oxide in the oxide sol) to stably exist dispersed.

However, when the pH value of the sealing material paste increases to, for example, more than about 6, it is considered that polyvalent metal ions such as Ca²⁺ (calcium ion), and Mg²⁺ (magnesium ion) contained in the biosoluble fibers elute and interfere with the surface charge of the inorganic particles and/or the oxide sol. Due to the interference, the charge balance on the surface of the inorganic particles and/or the oxide sol is disturbed so that the inorganic particles and/or the oxide sol may aggregate, presumably causing gelation of the sealing material.

The term “gelation” used herein refers to a phenomenon of viscosity increase due to aggregation, assembly, or phase change of solid components dispersed in a sol, which is caused by changes in the pH, presence of a polyvalent metal ion, and may cause increase of the viscosity of the sealing material paste.

As a result of the intensive studies based on the above findings, the present inventor has found that gelation of the sealing material tends to be prevented from occurring by using a sealing material paste that has been adjusted to be acidic upon preparation of the sealing material.

Although the mechanism is not clearly known, adjusting the sealing material paste to be acidic tends to prevent the polyvalent metal ions from eluting from the biosoluble fibers, and thus gelation of the sealing material tends to be prevented from occurring.

Examples of a method of adjusting a sealing material paste to be acidic include a method of using an acidic oxide sol, a method of mixing an alkali oxide sol and an acidic solution and the like.

In the case where the sealing material paste is acidic, it may become easier to prevent gelation of the sealing material. However, there is still a problem that when the acidic sealing material is solidified, the strength of the solidified sealing material is smaller than the strength of the sealing material which is solidified prior to acidification. For example, when the aforementioned sealing material is used as a peripheral sealing material, the peripheral sealing material layer to be formed tends to have a low strength. For this reason, damages such as cracks tend to occur in the peripheral sealing material layer during production or use of the honeycomb structure. As a result, problems may occur such as leakage of a catalyst-containing solution during catalyst addition in the production of the honeycomb structure, or leakage of exhaust gases in an exhaust gas purifying apparatus using the honeycomb structure. Further, when the sealing material is used as an adhesive for an aggregated honeycomb structure, the adhesive layer to be formed tends to have a low strength. For this reason, the honeycomb fired bodies may slide or, in extreme cases, may come off in an exhaust gas purifying apparatus using the honeycomb structure.

In order to solve the aforementioned problems, the inventor of the present invention has intensively examined causes of the reduction in the strength of the acidic sealing material after being solidified. The inventor has speculated that the polyvalent metal ions eluted in the sealing material, which are considered to cause gelation of the sealing material, have some influences on maintenance (improvement) of the strength of the solidified sealing material. After further studies based on this idea, the inventor of the present invention has reached to the following conclusion. Namely, when the sealing material is acidic, elution of the polyvalent metal ions is prevented as mentioned earlier. As a result, the amount of the polyvalent metal ions in the sealing material becomes low or the polyvalent metal ions do not exist in the sealing material, thereby reducing the strength of the solidified sealing material.

Based on the foregoing study results, the present inventor has found that, when gelation of the sealing material is prevented by adjusting the sealing material to be acidic and also a predetermined polyvalent metal ion is added to the sealing material, the strength of the solidified sealing material tends to be prevented from decreasing.

The mechanism of preventing gelation of the sealing material and the mechanism of preventing reduction in the strength of the solidified acidic sealing material mentioned earlier may be other mechanisms as long as the same effects due to the configuration of the present invention can be achieved, and thus should not be interpreted limitedly.

An embodiment of the present invention is able to provide a sealing material for a honeycomb structure, which contains well-biosoluble inorganic fibers, has good applicability to the ceramic block and the like even long after the preparation of the sealing material paste, and tends to prevent strength reduction after being solidified.

An embodiment of the present invention is able to obtain a honeycomb structure produced by using the aforementioned sealing material for a honeycomb structure, and to obtain a method for producing the aforementioned honeycomb structure.

The sealing material for a honeycomb structure according to the embodiment of the present invention includes inorganic fibers containing a biosoluble inorganic compound; an oxide sol; inorganic particles; and a metal-containing material that contains at least one of Mg (magnesium), Ca (calcium), and Sr (strontium), and the sealing material is acidic.

The inorganic fibers included in the sealing material for a honeycomb structure according to the embodiment of the present invention contain a biosoluble inorganic compound. Therefore, even if the inorganic fibers are taken into a human body, as they are soluble under physiological conditions, safety for human body of the sealing material for a honeycomb structure containing the inorganic fibers tends to be secured.

Hereinafter, the inorganic fibers containing a biosoluble inorganic compound are also referred to as “biosoluble fibers” in this description.

Since the sealing material for a honeycomb structure according to the embodiment of the present invention is acidic, elution of a polyvalent metal ion from the biosoluble fibers tends to be suppressed, thereby making it easier to prevent gelation of the sealing material.

Accordingly, even long after the preparation of the sealing material paste, it may become easier to prevent decrease in the flowability of the sealing material paste caused by increase in the viscosity of the sealing material paste.

Further, the sealing material for a honeycomb structure according to the embodiment of the present invention includes a metal-containing material that contains at least one of Mg, Ca, and Sr.

Thus, it may become easier to supply the sealing material with the polyvalent metal ion that is necessary for maintaining (improving) the strength of the sealing material even when elution of the polyvalent metal ion is suppressed due to the sealing material being acidic. Therefore, the strength of the solidified sealing material tends to be prevented from decreasing.

In the sealing material for a honeycomb structure according to the embodiment of the present invention, the inorganic compound is preferably at least one of an alkali metal compound and an alkaline earth metal compound. Inclusion of the inorganic compound tends to improve the biosolubility of the inorganic fibers.

In the sealing material for a honeycomb structure according to the embodiment of the present invention, the metal-containing material is preferably at least one of calcium carbonate, calcium acetate, magnesium carbonate, magnesium nitrate, magnesium sulfate, and magnesium acetate. Those metal-containing materials are preferable because they do not only tend to readily supply the polyvalent metal ion that is necessary for maintaining (improving) the strength of the sealing material due to their easy ionization in the sealing material paste but they tend to be readily obtained as well.

The metal-containing material may include at least one of calcium carbonate and calcium acetate as the sealing material for a honeycomb structure according to the embodiment of the present invention. Since those calcium-containing materials are more easily ionized in the sealing material paste, they tend to readily supply the polyvalent metal ion that is necessary for maintaining (improving) the strength of the sealing material. Therefore, the calcium-containing materials tend to prevent a reduction in the strength of the solidified sealing material for a honeycomb structure.

When the calcium content in the sealing material for a honeycomb structure is from about 0.01% to about 1.0% by weight as the sealing material for a honeycomb structure according to the embodiment of the present invention, it may become easier to favorably prevent a reduction in the strength of the solidified sealing material for a honeycomb structure.

The calcium content of about 0.01% by weight or more in the sealing material for a honeycomb structure may easily and sufficiently achieve the effects of maintaining or improving the strength of the solidified sealing material. The calcium content of about 1.0% by weight or less in the sealing material for a honeycomb structure is less likely to reduce the relative amounts of other components such as inorganic fibers, an oxide sol and inorganic particles in the sealing material for a honeycomb structure. As a result, the strength of the solidified sealing material for a honeycomb structure as a whole is less likely to be reduced.

The honeycomb structure according to the embodiment of the present invention includes a ceramic block which includes a honeycomb fired body in which a large number of cells are longitudinally placed in parallel with one another with a cell wall interposed therebetween; and a peripheral sealing material layer formed on a peripheral surface of the ceramic block. The peripheral sealing material layer is formed by solidifying the sealing material for a honeycomb structure described above.

The honeycomb structure according to the embodiment of the present invention contains biosoluble fibers as one of the materials forming the peripheral sealing material layer. For this reason, the honeycomb structure is highly safe for human body and tends to be safely handled by users such as operators and consumers. Moreover, gelation of the sealing material for a honeycomb structure is less likely to occur in manufacturing of the honeycomb structure according to the embodiment of the present invention. Therefore, it may become easier to prevent uneven thickness of the peripheral sealing material layer caused by difficulty in evenly applying the sealing material in forming the peripheral sealing material layer. Accordingly, it may become easier to prevent variation or reduction in the strength caused by uneven thickness of the peripheral sealing material layer.

Furthermore, in the honeycomb structure according to the embodiment of the present invention, the peripheral sealing material layer is formed by solidifying the sealing material for a honeycomb structure described above. Therefore, the polyvalent metal ion necessary for maintaining (improving) the strength of the sealing material tends to be supplied in the sealing material, which prevents a reduction in the strength of the peripheral sealing material layer. As a result, damages such as cracks tend to be prevented from occurring in the peripheral sealing material layer during manufacturing or use of the honeycomb structure. Therefore, it may become easier, for example, to prevent problems such as leakage of the solution containing the catalyst in the catalyst addition in manufacturing of the honeycomb structure, or leakage of exhaust gases from an exhaust gas-purifying apparatus using the honeycomb structure.

The honeycomb structure according to the embodiment of the present invention contains a ceramic block which includes a plurality of honeycomb fired bodies; and an adhesive layer formed between side surfaces of a plurality of the honeycomb fired bodies.

The honeycomb structure according to the embodiment of the present invention may be an integral honeycomb structure in which the ceramic block includes a single honeycomb fired body, or may be an aggregated honeycomb structure in which the ceramic block includes a plurality of the honeycomb fired bodies.

The adhesive layer may be formed of a solidified adhesive as the honeycomb structure according to the embodiment of the present invention.

In the honeycomb structure according to the embodiment of the present invention, the adhesive is the sealing material for a honeycomb structure described above.

In a honeycomb structure in which a plurality of the honeycomb fired bodies are aggregated, adhesive layers are necessary between the honeycomb fired bodies, leading inevitably to increase in the total amount of the inorganic fibers contained in the honeycomb structure. In the case of a conventional honeycomb structure, as the amount of the adhesive layers increases, the inorganic fibers are more likely to be taken into human body. On the other hand, in the case of the honeycomb structure according to the embodiment of the present invention, since the adhesive is the sealing material for a honeycomb structure described above, it may become easier to secure the safety of human body even when the total amount of the inorganic fibers contained in the honeycomb structure as a whole increases.

Moreover, in the honeycomb structure according to the embodiment of the present invention, the sealing material for a honeycomb structure described above is used as an adhesive. Therefore, it may become easier to supply the adhesive (sealing material) with the polyvalent metal ion that is necessary for maintaining (improving) the strength of the adhesive (sealing material). Accordingly, the strength of the adhesive layer tends to be prevented from decreasing. As a result, it may become easier, for example, to prevent problems such as sliding or in extreme cases coming off of the honeycomb fired body in an exhaust gas purifying apparatus which uses the honeycomb structure.

The method for manufacturing a honeycomb structure according to the embodiment of the present invention is a method for manufacturing a honeycomb structure including a ceramic block which includes a honeycomb fired body in which a large number of cells are longitudinally placed in parallel with one another with a cell wall interposed therebetween; and a peripheral sealing material layer formed on a peripheral surface of the ceramic block, the method including: preparing a sealing material for a honeycomb structure containing inorganic fibers including a biosoluble inorganic compound, an oxide sol, inorganic particles, and a metal-containing material that contains at least one of Mg, Ca, and Sr, the sealing material for a honeycomb structure being acidic; and forming the peripheral sealing material layer by forming a peripheral sealing material paste layer including the sealing material for a honeycomb structure on a peripheral surface of the ceramic block and solidifying the peripheral sealing material paste layer.

In the method for manufacturing a honeycomb structure according to the embodiment of the present invention, since the sealing material for a honeycomb structure, which is prepared in preparing the sealing material for a honeycomb structure, is acidic, it may become easier to prevent elution of the polyvalent metal ions from the biosoluble fiber, and thus gelation of the sealing material tends to be avoided. Accordingly, it may become easier to prevent decrease in the flowability of the sealing material paste caused by increase in the viscosity of the sealing material paste even long after the preparation of the sealing material paste. Moreover, as the flowability of the sealing material for a honeycomb structure tends to be kept at a high level, it is easy to manage the use and the like of the sealing material. Further, it may become easier to avoid reduction of the processability in forming the peripheral sealing material paste on the peripheral surface of the ceramic block in forming the peripheral sealing material layer.

According to the method for manufacturing a honeycomb structure according to the embodiment of the present invention, a peripheral sealing material layer which contains inorganic fibers including a biosoluble inorganic compound tends to be formed. Therefore, it may become easier to manufacture a honeycomb structure which is highly safe for human body. Moreover, use of the biosoluble fiber allows operators to safely work in preparing the sealing material for a honeycomb structure and forming a peripheral sealing material layer.

Further, the sealing material for a honeycomb structure prepared in preparing the sealing material for a honeycomb structure contains a metal-containing material including at least one of Mg, Ca, and Sr.

Thus, it may become easier to supply the sealing material with the polyvalent metal ion that is necessary for maintaining (improving) the strength of the sealing material even when elution of the polyvalent metal ion is suppressed due to the sealing material being acidic. Therefore, the strength of the solidified sealing material tends to be prevented from decreasing. Asa result, it may become easier to prevent damages such as cracks from occurring in the peripheral sealing material layer.

The method for manufacturing a honeycomb structure according to the embodiment of the present invention further includes bonding for constructing the ceramic block, the ceramic block containing a plurality of the honeycomb fired bodies which are bonded with one another with an adhesive layer interposed therebetween, the bonding of a plurality of the honeycomb fired bodies including: preparing a honeycomb aggregated body in which a plurality of the honeycomb fired bodies are bonded with one another with an adhesive layer paste interposed therebetween; and solidifying the adhesive layer paste to form the adhesive layer.

By including this bonding, it is possible to manufacture an aggregated honeycomb structure formed by bonding a plurality of the honeycomb fired bodies.

In the method for manufacturing a honeycomb structure according to the embodiment of the present invention, the foregoing sealing material for a honeycomb structure is used as the adhesive layer paste.

Since the adhesive layer paste (sealing material) for a honeycomb structure is acidic, it may become easier to prevent elution of the polyvalent metal ions from the biosoluble fiber, and thus gelation of the adhesive layer paste (sealing material) tends to be avoided. Accordingly, it may become easier to prevent decrease in the flowability of the adhesive layer paste (sealing material paste) caused by increase in the viscosity of the adhesive layer paste (sealing material paste) even long after the preparation of the adhesive layer paste (sealing material paste). Moreover, as the flowability of the adhesive layer paste (sealing material) for a honeycomb structure tends to be kept at a high level, it is easy to manage the use and the like of the adhesive layer paste (sealing material). Further, it may become easier to avoid reduction of the processability in bonding a plurality of the honeycomb fired bodies by interposing the adhesive layer paste (sealing material for the honeycomb structure).

According to the method for manufacturing a honeycomb structure according to the embodiment of the present invention, an adhesive layer which contains the inorganic fibers including a biosoluble inorganic compound tends to be formed. Accordingly, it may become easier to manufacture a honeycomb structure which is highly safe for human body. Moreover, use of the biosoluble fibers allows operators to safely work in the bonding of a plurality of the honeycomb fired bodies.

Furthermore, the sealing material for a honeycomb structure contains a metal-containing material including at least one of Mg, Ca, and Sr.

Thus, it may become easier to supply the sealing material with the polyvalent metal ion that is necessary for maintaining (improving) the strength of the sealing material even when elution of the polyvalent metal ion is suppressed due to the sealing material being acidic. Therefore, the strength of the solidified sealing material tends to be prevented from decreasing, enabling solid fixation of the honeycomb fired bodies. Accordingly, it may become easier to manufacture a honeycomb structure which tends to be stably used for a long period of time.

In the method for manufacturing a honeycomb structure according to the embodiment of the present invention, the inorganic compound is at least one of an alkali metal compound and an alkaline earth metal compound. Use of the inorganic compound allows the inorganic fibers to act specifically as biosoluble fibers. As a result, it may become easier to enhance the safety of the sealing material for a honeycomb structure or ultimately the honeycomb structure including the sealing material for human body.

In the method for manufacturing a honeycomb structure according to the embodiment of the present invention, the metal-containing material is preferably at least one of calcium carbonate, calcium acetate, magnesium carbonate, magnesium nitrate, magnesium sulfate, and magnesium acetate.

The foregoing metal-containing materials are very easily available and tend to be readily handled. Therefore, preparation for production tends to be facilitated and processability during the manufacturing of the honeycomb structure tends to be improved. Moreover, since the foregoing metal-containing materials are easily ionized in the sealing material paste, they tend to readily supply the polyvalent metal ion that is necessary for maintaining (improving) the strength of the sealing material for a honeycomb structure. Therefore, the metal-containing materials tend to prevent a reduction in the strength of the solidified sealing material for a honeycomb structure.

In the method for manufacturing a honeycomb structure according to the embodiment of the present invention, the metal-containing material preferably includes at least one of calcium carbonate and calcium acetate.

Since the foregoing calcium-containing materials are more easily ionized in the sealing material paste, they tend to readily supply the polyvalent metal ion that is necessary for maintaining (improving) the strength of the sealing material for a honeycomb structure. Therefore, the calcium-containing materials tend to prevent a reduction in the strength of the solidified sealing material for a honeycomb structure.

When the calcium content in the sealing material for a honeycomb structure is from about 0.01% by weight to about 1.0% by weight as in the method for manufacturing a honeycomb structure according to the embodiment of the present invention, reduction in the strength of the solidified sealing material for a honeycomb structure tends to be favorably prevented.

In the case where the calcium content in the sealing material for a honeycomb structure is about 0.01% by weight or more, the effect of maintaining or improving the strength of the solidified sealing material may be easily and sufficiently achieved, and thus the strength of the peripheral sealing material layer or the adhesive layer is less likely to be reduced. In the case where the calcium content in the sealing material for a honeycomb structure is about 1.0% by weight or less, the relative amounts of other components, such as inorganic fibers, an oxide sol, and inorganic particles, in the sealing material for a honeycomb structure are less likely to be reduced. As a result, the strength of the solidified sealing material for a honeycomb structure as a whole is less likely to be reduced, which enable to prevent the strength of the peripheral sealing material layer or the adhesive layer from being reduced.

### First Embodiment

The following description will discuss embodiments of the sealing material for a honeycomb structure, the honeycomb structure, and the method for manufacturing the honeycomb structure of according to the embodiment of the present invention with reference to drawings.

First, the sealing material for a honeycomb structure according to the present embodiment will be discussed below.

The sealing material for a honeycomb structure of the present embodiment includes inorganic fibers containing a biosoluble inorganic compound; an oxide sol; inorganic particles; and a metal-containing material that contains at least one of Mg, Ca, and Sr, and the sealing material is acidic.

In order to evaluate the biosolubility of the inorganic fibers containing an inorganic compound, the solubility of the inorganic compound contained in the inorganic fibers in physiological saline is measured by the following method. The inorganic fibers in an amount of 0.5 g are added in 25 ml of physiological saline. The resulting product is shaken for about five hours at a temperature of about 37° C. and then filtrated to remove solid content of the inorganic fibers. The extracted solution in which a portion of the inorganic fibers is dissolved is analyzed by atomic absorption spectrometry to measure the elements in the inorganic fibers such as silicon, sodium, calcium, and magnesium in the extracted solution. The physiological saline may be a commonly used one. It is considered that when the total amount of the target compounds dissolved in the extracted solution is about 100 ppm (about 0.01% by weight) or more, the inorganic fibers can be determined as inorganic fibers including biosoluble inorganic compounds. The ratio of the eluted material having been eluted from the inorganic fibers can be calculated based on the result of the measurement. In the case where the physiological saline originally contains the element to be measured, the amount of the element in the physiological saline is previously confirmed so that the amount is subtracted from the measured amount of the element in the sample.

It is desirable that the solubility of the inorganic fibers contained in the sealing material for a honeycomb structure of the present embodiment in physiological saline at about 37° C. is about 300 ppm (about 0.03% by weight) or more. It is considered that the inorganic fibers having a solubility of about 300 ppm (about 0.03% by weight) or more is immediately dissolved under physiological conditions, making it easier to further reduce risks caused upon taking of the inorganic fibers in a human body.

The inorganic compound in the inorganic fibers contained in the sealing material for a honeycomb structure of the present embodiment is at least one of an alkali metal compound and an alkaline earth metal compound.

Examples of the alkali metal compound include sodium oxides or salts, and potassium oxides or salts. Examples of the alkaline earth metal compound include magnesium oxides or salts, calcium oxides or salts, and barium oxides or salts. Biosoluble fibers can be obtained by allowing the materials of inorganic fibers such as silica, alumina, silica alumina, or glass to contain sodium oxides or salts, potassium oxides or salts, magnesium oxides or salts, calcium oxides or salts, barium oxides or salts, or boron oxides or salts.

The inorganic fibers included in the sealing material for a honeycomb structure of the present embodiment preferably contain silica in an amount of from about 60% by weight to about 85% by weight, or more preferably from about 70% by weight to about 80% by weight, in addition to the foregoing inorganic compound. The silica refers to SiO or SiO₂. The silica content of about 60% by weight or more is less likely to reduce the strength of the inorganic fibers. The silica content of about 85% by weight or less is less likely to cause a reduction in the biosolubility due to the reduced amount of the inorganic compound in the inorganic fibers.

The inorganic fibers included in the sealing material for a honeycomb structure of the present embodiment preferably contain at least one of a biosoluble alkali metal compound and a biosoluble alkaline earth metal compound. The inorganic fibers preferably contain about 70% by weight or more of SiO₂. Generally, many of alkali metal silicates and alkaline earth metal silicates are biosoluble. However, the SiO₂ content of about 85% by weight or less is preferable as the amount of the alkali metal compound or the alkaline earth metal compound, which has biosolubility, is less likely to become too small.

Moreover, the Al₂O₂ content of the inorganic fibers included in the sealing material for a honeycomb structure of the present embodiment is preferably about 2% by weight or less. The Al₂O₂ content may be 0% by weight as long as the content is about 2% by weight or less, on the ground that generally an alkali metal aluminate or an alkali metal aluminosilicate and an alkaline earth metal aluminate or an alkaline earth metal aluminosilicate have no or little biosolubility.

Inorganic fibers are an inorganic material with a large aspect ratio (major axis/minor axis). Generally, it is considered that inorganic fibers are especially effective for improving the elasticity of sealing materials.

The aspect ratio of the inorganic fibers included in the sealing material for a honeycomb structure of the present embodiment is preferably from about 2 to about 1000, more preferably from about 5 to about 800, and furthermore preferably from about 10 to about 500. When the aspect ratio of the inorganic fibers is about 2 or more, the inorganic fibers may easily contribute to improving the elasticity of the sealing material. When the aspect ratio of the inorganic fibers is about 1000 or less, the bonding strength to bond the honeycomb fired bodies is less likely to be reduced. In the case where there is a distribution in the aspect ratio, the aspect ratio is expressed as an average value.

The lower limit of the amount of the inorganic fibers contained in the sealing material for a honeycomb structure of the present embodiment is preferably about 10% by weight and more preferably about 20% by weight as a solid content. The upper limit of the amount of the inorganic fibers is preferably about 70% by weight, more preferably about 40% by weight, and further more preferably about 30% by weight as a solid content. The inorganic fiber content of about 10% by weight or more as a solid content is less likely to cause a reduction in the elasticity of the sealing material due to the reduced content of the inorganic fibers contributing to the elasticity. The inorganic fiber content of about 70% by weight or less as a solid content is less likely to induce a reduction in the thermal conductivity and a reduction in the bonding strength of the sealing material due to the reduced content of the inorganic particles contributing to the thermal conductivity.

Moreover, the lower limit of the average fiber length of the inorganic fibers included in the sealing material for a honeycomb structure of the present embodiment is preferably about 0.1 μm. The upper limit of the average fiber length of the aforementioned inorganic fibers is preferably about 1000 μm, more preferably about 100 μm, and further more preferably about 50 μm.

The average fiber length of about 0.1 μm or more is less likely to reduce the elasticity of the sealing material. The average fiber length of about 1000 μm or less tends not to make the inorganic fibers form a pill-like shape. As a result, it may become easier to reduce the thickness of the adhesive layer or the peripheral sealing material layer, or the dispersibility of the inorganic particles in the sealing material may be improved.

The oxide sol contained in the sealing material for a honeycomb structure mainly functions as a binder to bond particles together after solidification of the sealing material. Examples of the oxide sol include silica sol, alumina sol, zirconia sol and the like. These may be used alone, or two or more kinds of these may be used in combination. Silica sol or alumina sol is preferably used among these.

The lower limit of the amount of the oxide sol contained in the sealing material for a honeycomb structure is preferably about 1% by weight, and more preferably about 5% by weight as a solid content. The upper limit thereof is preferably about 30% by weight, more preferably about 15% by weight, and further more preferably about 9% by weight as a solid content. The amount of the oxide sol of about 1% by weight or more as a solid content is less likely to cause a reduction in the bonding strength due to the reduced content of the oxide sol functioning as a binder. The amount of the oxide sol of about 30% by weight or less as a solid content is less likely to cause a reduction in the thermal conductivity of the sealing material due to reduced content of the inorganic particles contributing to the thermal conductivity.

The average particle diameter of the oxide included in the oxide sol in the sealing material for a honeycomb structure is preferably from about 5 nm to about 30 nm.

The smaller the average particle diameter of the oxide contained in the oxide sol is, the more the bonding strength to bond the honeycomb fired bodies tends to improve. However, when the average particle diameter of the oxide is about 5 nm or more, the dispersibility of the oxide in the sealing material is less likely to be deteriorated. Further, the oxide having the average particle diameter of about 5 nm or more is easily to manufacture and thus is easily available. When the average particle diameter of the oxide is about 30 nm or less, the bonding sites among particles are less likely to be decreased to cause a reduction in the bonding strength to bond the honeycomb fired bodies.

In this description, the average particle diameter of the oxide contained in the oxide sol is measured, for example, by using the following method.

When the oxide sol is a silica sol, first, the silica sol is dried, and its BET specific surface area is measured.

Thereafter, supposing that silica particles in the silica sol are spherical particles of a dense body, the particle diameter is calculated from the following formula (I):

BET specific surface area=(6000/ρ)/particle diameter (1)

(in the formula, “ρ” is the true density of silica (2.2 g/cm³))

Examples of the inorganic particles contained in the sealing material for a honeycomb structure may include carbide particles, nitride particles and the like, and specific examples thereof may include inorganic powders, whiskers and the like, which are made of silicon carbide, silicon nitride, boron nitride and the like. Each of these may be used alone, or two or more kinds of these may be used in combination. Silicon carbide particles, which are superior in thermal conductivity, are more preferably used among the inorganic particles.

It should be noted that, although whiskers may be categorized as inorganic fibers, whiskers are included in the inorganic particles in the present description.

The lower limit of the amount of the inorganic particles contained in the sealing material for a honeycomb structure is preferably about 3% by weight, more preferably about 10% by weight, and further more preferably about 20% by weight. The upper limit of the amount of the inorganic particles is preferably about 80% by weight, more preferably about 60% by weight, and further more preferably about 40% by weight. The amount of the inorganic particles of about 3% by weight or more is less likely to cause a reduction in the thermal conductivity of the sealing material due to the reduced content of the inorganic particles. In the case where the amount of the inorganic particles is about 80% by weight or less, when exposure of the adhesive layer or the peripheral sealing material layer to high temperatures causes expansion of the inorganic particles with a high coefficient of thermal expansion, small cracks are less likely to occur near the expansion site. As a result, the bonding strength of the sealing material as a whole is less likely to be reduced.

The lower limit of the average particle diameter of the inorganic particles contained in the sealing material for a honeycomb structure is preferably about 0.01 μm, and more preferably about 0.1 μm. The upper limit of the average particle diameter of the inorganic particles is preferably about 100 μm, more preferably about 15 μm, and further more preferably about 10 μm. The average particle diameter of the inorganic particles of about 0.01 μm or more is less likely to reduce the dispersibility of the inorganic particles in the sealing material and is less likely to increase the cost. The average particle diameter of the inorganic particles of about 100 μm or less is less likely to induce a reduction in the bonding strength or the thermal conductivity of the sealing material.

Examples of the metal-containing material contained in the sealing material for a honeycomb structure according to the present embodiment may include salts, complexes or the like containing a metal which is easily ionized under acidic conditions, such as Mg, Ca, or Sr. These may be used alone, or two or more kinds of these may be used in combination. Examples of the salts containing at least one of Mg, Ca, and Sr include a carbonate, a nitrate, a sulfate, a phosphate, an acetate, a citrate, an oxalate or the like of at least one of Mg, Ca, and Sr. Examples of the complexes containing at least one of Mg, Ca, and Sr include: an inorganic complex containing a carbonate ion, a sulfate ion, a phosphate ion or the like as an inorganic ligand; and an organic complex containing dicarboxylic acids, diamines, or derivatives thereof as an organic ligands.

Calcium carbonate, calcium acetate, magnesium carbonate, magnesium nitrate, magnesium sulfate or magnesium acetate is preferable, and calcium carbonate or calcium acetate is more preferable among the above metal-containing materials. Those metal-containing materials are easily ionized in the sealing material paste. Accordingly, the metal-containing materials tend to easily provide polyvalent metal ions which are necessary for maintaining (improving) the strength of the sealing material for a honeycomb structure and thus tends to prevent a reduction in the strength of the solidified sealing material for a honeycomb structure. Those metal-containing materials are also desirable for the easy availability.

When the sealing material for a honeycomb structure of the present embodiment includes the metal-containing material, the polyvalent ion that is necessary for maintaining (improving) the strength of the sealing material for a honeycomb structure tends to be supplied in the sealing material. Therefore, the strength of the solidified sealing material tends to be prevented from decreasing.

In the case where the metal-containing material included in the sealing material for a honeycomb structure of the present embodiment includes at least one of calcium carbonate and calcium acetate, the lower limit of the calcium content contained in the sealing material for a honeycomb structure is preferably about 0.01% by weight and more preferably about 0.1% by weight. The upper limit of the calcium content is preferably about 1.0% by weight and more preferably about 0.5% by weight.

When the calcium content is about 0.01% by weight or more, the effect to maintain or improve the strength of the solidified sealing material may be easily and sufficiently achieved. When the calcium content is about 1.0% by weight or less, the relative amounts of the other components which are the inorganic fibers, the oxide sol, and the inorganic particles in the sealing material for a honeycomb structure is less likely to become small. Asa result, the strength of the solidified sealing material for a honeycomb structure as a whole is less likely to be reduced.

The sealing material for a honeycomb structure of the present embodiment preferably includes an organic binder. Examples of the organic binder include polyvinyl alcohol, methylcellulose, ethylcellulose, carboxymethylcellulose and the like. These may be used alone, or two or more kinds of these may be used in combination. Carboxymethylcellulose is preferably used among the organic binders because it is excellent in the control of the viscosity of the sealing material.

The lower limit of the amount of the organic binder included in the sealing material for a honeycomb structure of the present embodiment is preferably about 0.1% by weight, more preferably about 0.2% by weight, and further more preferably about 0.4% by weight as a solid content. The upper limit of the amount of the organic binder contained in the sealing material for a honeycomb structure is preferably about 5.0% by weight, more preferably about 1.0% by weight, and further more preferably about 0.6% by weight as a solid content. In the case of the solid content of the organic binder of about 0.1% by weight or more, the sealing material easily turns into a paste because the viscosity of the sealing material tends not to be too low. Thus, application of the sealing material may become easy. The solid content of the organic binder of about 5.0% by weight or less may not result in a sealing material having excessively high viscosity, and thus application of the sealing material may become easy. Moreover, when the adhesive layer or the peripheral sealing material layer is exposed to high temperatures, the organic components in the sealing material evaporate. As a result, the parts where the organic components have evaporated in the sealing material may form cavities. Further, when the solid content of the organic binder is about 5.0% by weight or less, the ratio of content of the organic components contained in the sealing material for a honeycomb structure is not too high. As a result, the portion of the cavities formed upon evaporation of the organic components in the sealing material tend not to increase, rarely causing a reduction in the strength of the adhesive layer or the peripheral sealing material.

The preferable components constituting the sealing material for a honeycomb structure of the present embodiments and the respective amounts are: from about 30% by weight to about 40% by weight of inorganic fibers containing SiO₂, MgO, CaO, and Al₂O₃; from about 15% by weight to about 20% by weight of silica sol; from about 30% by weight to about 40% by weight of silicon carbide particles; from about 0.01% by weight to about 1% by weight of calcium carbonate; and from about 0.4% by weight to about 0.6% by weight of carboxymethyl cellulose.

The sealing material (sealing material paste) for a honeycomb structure of the present embodiment is acidic.

Although the pH value of the sealing material for a honeycomb structure is not particularly limited as long as the sealing material is acidic, the sealing material preferably has a pH value in a range of about 4 to about 6. When the sealing material for a honeycomb structure has a pH value of about 4 or more, the inorganic particles are less likely to aggregate in the prepared sealing material paste. When the sealing material has a pH value of about 6 or less, gelation of the prepared sealing material paste is less likely to occur.

As the method for preparing the sealing material for a honeycomb structure by adjusting the pH value of the sealing material to be in a range of about 4 to about 6, for example, a method using an acidic oxide sol or the like may be exemplified.

Although the pH value of the acidic oxide sol is not particularly limited, the acidic oxide sol preferably has a pH value of about 3 to about 6. When the oxide sol has a pH value of about 3 or more, the pH value of the prepared sealing material paste is less likely to become too low, which is less likely to cause aggregation of the inorganic particles. When the oxide sol has a pH value of about 6 or less, the pH value of the prepared sealing material paste is less likely to become too high, which is less likely to cause gelation of the sealing material.

An acidic silica sol or an acidic alumina sol may be preferably used as the acidic oxide sol.

The following description will discuss the method for preparing the sealing material for a honeycomb structure of the present embodiment.

An acidic sealing material for a honeycomb structure is prepared by mixing the inorganic fibers, the inorganic particles, the metal-containing material, and the organic binder at the ratio mentioned earlier to prepare a mixture, and then adding an acidic oxide sol and an appropriate amount of water in the mixture, followed by kneading.

Accordingly, it is possible to prepare a sealing material for a honeycomb structure which contains well-biosoluble inorganic fibers, has good applicability to the ceramic block and the like even long after the preparation of the sealing material paste, and tends to prevent strength reduction after being solidified.

The following description will discuss the honeycomb structure according to an embodiment of the present invention.

The honeycomb structure of the present embodiment is manufactured by using the aforementioned sealing material for a honeycomb structure of the present embodiment.

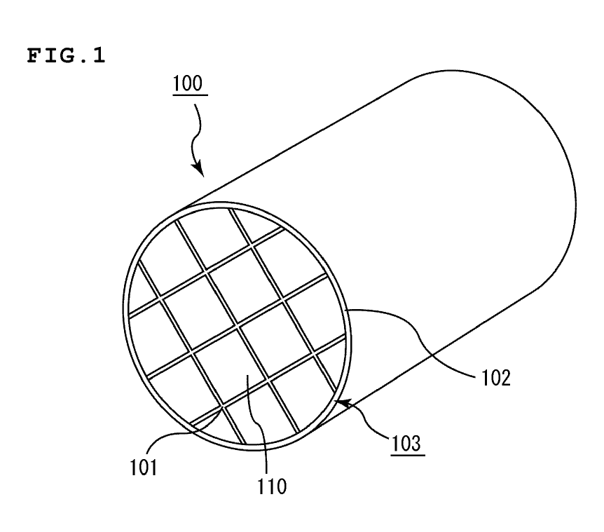

FIG. 1 is a perspective view that schematically shows one example of a honeycomb structure according to an embodiment of the present invention.

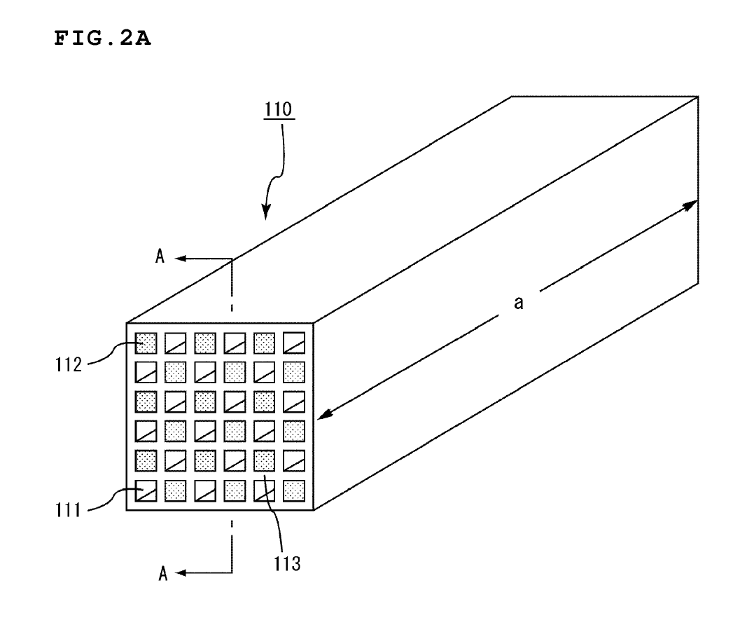

FIG. 2A is a perspective view that schematically shows one example of a honeycomb fired body that constitutes the honeycomb structure according to an embodiment of the present invention, and FIG. 2B is an A-A line cross-sectional view of the honeycomb fired body shown in FIG. 2A.

A honeycomb structure 100 according to an embodiment of the present invention shown in FIG. 1 has a structure in which a plurality of porous silicon carbide honeycomb fired bodies 110 are bonded with one another with an adhesive layer 101 interposed therebetween to construct a ceramic block 103, with a peripheral sealing material layer 102 formed on the periphery face of the ceramic block 103.

The honeycomb fired body 110 has a shape shown in FIGS. 2A and 2B.

The honeycomb fired body 110 shown in FIGS. 2A and 2B has a structure in which a large number of cells 111 are longitudinally (the direction “a” in FIG. 2A) placed in parallel with one another with a cell wall 113 therebetween, and either one end of each of the cells 111 is plugged with a plug 112. Therefore, exhaust gases “G” having flowed into one of the cells 111 with an opening end on one end face surely passes through the cell wall 113 that separates the cells 111, and flows out from another cell 111 with an opening end on the another end face.

Therefore, the cell wall 113 functions as a filter for capturing PM and the like.

In the honeycomb structure 100 of the present embodiment, the adhesive layer 101 and the peripheral sealing material layer 102 are formed by using the sealing material for a honeycomb structure of the present embodiment.

The following description will discuss the method for manufacturing a honeycomb structure according to embodiments of the present invention.

First, molding for manufacturing a honeycomb molded body is performed by extrusion-molding a wet mixture containing ceramic powders and a binder.

Specifically, as the ceramic powders, silicon carbide powders having different average particle diameters, an organic binder, a plasticizer in liquid form, a lubricant and water are mixed to prepare a wet mixture for manufacturing a honeycomb molded body.

Successively, this wet mixture is loaded into an extrusion molding machine and extrusion-molded so that a honeycomb molded body having a predetermined shape is manufactured.

Next, the honeycomb molded body is cut into a predetermined length, and dried by using a drying apparatus, such as a microwave drying apparatus, a hot-air drying apparatus, a dielectric drying apparatus, a reduced-pressure drying apparatus, a vacuum drying apparatus, and a freeze drying apparatus. Thereafter, plugging is carried out by filling predetermined cells with a plug material paste to be a plug for plugging the cells.

Next, degreasing is carried out to remove the organic components in the honeycomb molded body by heating the honeycomb molded body in a degreasing furnace. The degreased honeycomb molded body is transferred to a firing furnace to carry out firing so that a honeycomb fired body is manufactured.

Here, conditions conventionally used upon manufacturing a honeycomb fired body are applicable for carrying out the cutting, drying, sealing, degreasing and firing.

Next, bonding is carried out by forming the adhesive layer between a plurality of the honeycomb fired bodies so that the plurality of the honeycomb fired bodies are bonded with one another with the adhesive layer interposed therebetween according to the following method.

An paste-like adhesive including the sealing material for a honeycomb structure of the present embodiment is applied on a predetermined side surface of each of the honeycomb fired bodies in which a predetermined end of each of the cells is plugged so as to form an adhesive paste layer. On the adhesive paste layer is placed one of other honeycomb fired bodies, and this process is sequentially repeated so that a honeycomb aggregated body in which the plurality of the honeycomb fired bodies are bonded with one another with the adhesive paste layer interposed therebetween is manufactured.

Next, the adhesive paste layer is solidified by heating the honeycomb aggregated body so that a ceramic block having an adhesive layer is constructed.

Thereafter, periphery cutting is performed by cutting side surfaces of the ceramic block using a diamond cutter and the like so that the ceramic block has a round pillar shape.

Further, forming a peripheral sealing material layer on the peripheral surface of the ceramic block is carried out according to the following method.

A peripheral sealing material paste layer is formed by applying the sealing material for a honeycomb structure of the present embodiment using a squeeze. By solidifying the peripheral sealing material paste layer, a peripheral sealing material layer is formed.

According to the processes mentioned earlier, a honeycomb structure including the sealing material for a honeycomb structure (adhesive layer and peripheral sealing material layer) of the present embodiment can be manufactured.

The effects of the sealing material for a honeycomb structure, the honeycomb structure, and the method for manufacturing a honeycomb structure according to the present embodiment will be recited below.

(1) The inorganic fibers contained in the sealing material for a honeycomb structure of the present embodiment are biosoluble fibers. Therefore, even if the inorganic fibers are taken into human body, as they are soluble under physiological conditions, it may become easier to secure the safety for human body of the sealing material for a honeycomb structure containing the inorganic fibers.

Moreover, the honeycomb structure manufactured by including the sealing material for a honeycomb structure of the present embodiment is highly safe and tends to be safely handled by users such as operators and consumers.

Further, operators tend to safely work in the manufacture of a honeycomb structure by using the sealing material for a honeycomb structure of the present embodiment.

(2) Since the sealing material for a honeycomb structure of the present embodiment is acidic, it may become easier to prevent elution of the polyvalent metal ions from the biosoluble fibers. Therefore, gelation of the sealing material tends to be avoided.

Accordingly, it may become easier to prevent decrease in the flowability of the sealing material paste caused by increase in the viscosity of the sealing material paste even long after the preparation of the sealing material paste.

When forming the peripheral sealing material layer of the honeycomb structure by using the sealing material for a honeycomb structure of the present embodiment, gelation of the sealing material for a honeycomb structure is less likely to be occurred, and thus it may become easier to prevent uneven thickness of the peripheral sealing material layer because it may become easier to evenly apply the sealing material paste. Accordingly, it may become easier to prevent variation or reduction in the strength of the peripheral sealing material layer caused by uneven thickness of the peripheral sealing material layer.

(3) The sealing material for a honeycomb structure of the present embodiment contains a metal-containing material including at least one of Mg, Ca, and Sr. Thus it may become easier to supply the sealing material with the polyvalent metal ion that is necessary for maintaining (improving) the strength of the sealing material layer even when elution of the polyvalent metal ion is suppressed due to the sealing material being acidic. Therefore, the strength of the solidified sealing material tends to be prevented from decreasing.

(4) The honeycomb structure of the present embodiment is an aggregated honeycomb structure including a plurality of the honeycomb fired bodies.

In the honeycomb structure in which a plurality of the honeycomb fired bodies are aggregated, an adhesive layer is necessary between the honeycomb fired bodies. Therefore, the total amount of the inorganic fibers contained in the honeycomb structure tends to be increased. Even in this case, since the honeycomb structure of the present embodiment uses the sealing material for a honeycomb structure of the present embodiment as an adhesive, it may become easier to secure the safety of the honeycomb structure for human body.

(5) In the honeycomb structure of the present embodiment, the peripheral sealing material layer is formed by solidifying the sealing material for a honeycomb structure of the present embodiment. Since the sealing material for a honeycomb structure of the present embodiment shows almost no decrease in the strength after being solidified, damages such as cracks tend to be prevented from occurring in the peripheral sealing material layer.

(6) In the honeycomb structure of the present embodiment, the adhesive layer is formed by solidifying the sealing material for a honeycomb structure of the present embodiment. Since the sealing material for a honeycomb structure of the present embodiment shows almost no decrease in its strength after being solidified, it may become easier to prevent sliding or coming off of the honeycomb fired bodies which are bonded with one another with the adhesive layer interposed therebetween. Therefore, the honeycomb structure tend to be stably used for a long period of time.

(7) In the method for manufacturing a honeycomb structure of the present embodiment, when forming a peripheral sealing material layer, the sealing material for a honeycomb structure of the present embodiment is applied on a peripheral surface of the ceramic block. Further, when forming the adhesive layer, the sealing material for a honeycomb structure of the present embodiment is applied on a side surface of the honeycomb fired body. Since the sealing material for a honeycomb structure of the present embodiment shows almost no decrease in the flowability of the sealing material paste caused by increase in the viscosity of the sealing material paste even long after the preparation of the sealing material paste, it may become easier to prevent a reduction in the processability upon formation of the peripheral sealing material layer or the adhesive layer.

### EXAMPLES

Examples specifically disclosing the first embodiment of the present invention will be described below. The present invention is not limited to those Examples.

### (1) Preparation of Sealing Material for a Honeycomb Structure

In Examples and Comparative Examples, a sealing material for a honeycomb structure was prepared using the following oxide sol and inorganic fibers.

The oxide sol used in Examples and Comparative Examples was an acidic silica sol having the following compositions: 20.4% by weight of SiO₂, 0.11% by weight of Na₂O, 0.17% by weight of Al₂O₂, and 79.3% by weight of H₂O.

Further, the inorganic fibers used in Examples and Comparative Examples were biosoluble fibers having the following compositions: 70.8% by weight of SiO₂, 0.6% by weight of MgO, 25.9% by weight of CaO, 0.8% by weight of Al₂O₂, and 1.9% by weight of other components.

### Example 1

### Preparation of Sealing Material for a Honeycomb Structure

A sealing material for a honeycomb structure having a pH value of 6.7 was prepared by mixing 37.4% by weight of the biosoluble fibers as inorganic fibers, 31.4% by weight of SiC powders as inorganic particles, 0.03% by weight of calcium carbonate as a metal-containing material, 0.4% by weight of carboxymethyl cellulose (CMC) as an organic binder, 17.4% by weight of the acidic silica sol having an average particle diameter of 12 nm and a pH value of 6.7, and 13.4% by weight of water, followed by kneading.

### Examples 2 to 10

A sealing material for a honeycomb structure was prepared in the same manner as that in Example 1, except that the calcium content in the sealing material for a honeycomb structure was changed to the value shown in Table 1 by changing the amount of the calcium carbonate.

### Examples 11, 12

A sealing material for a honeycomb structure was prepared in the same manner as that in Example 1, except that magnesium carbonate or calcium sulfate was used in place of the calcium carbonate.

### Comparative Example 1

A sealing material for a honeycomb structure was prepared in the same manner as that in Example 1, except that the calcium carbonate was not added.

### Comparative Examples 2 to 6

A sealing material for a honeycomb structure was prepared in the same manner as that in Example 1, except that lithium carbonate, sodium carbonate, potassium carbonate, copper sulfate, or alminium sulfate was used in place of the calcium carbonate.

### (2) Evaluation of Sealing Material for a Honeycomb Structure

The sealing materials for a honeycomb structure prepared in Examples and Comparative Examples were evaluated according to the following method.

For evaluation of the sealing materials for a honeycomb structure, first, honeycomb fired bodies were prepared so as to prepare samples for evaluation. Each of the samples for evaluation included two pieces of the honeycomb fired bodies and the sealing material for a honeycomb structure. Thereafter, evaluation of the breaking strength was performed using the samples for evaluation.

Next, a ceramic block was constructed by bonding sixteen pieces of the honeycomb fired bodies using the sealing material for a honeycomb structure. By forming a peripheral sealing material layer on the periphery of the thus obtained ceramic block, a honeycomb structure was manufactured. By using the honeycomb structure, incidence of holes in the peripheral sealing material layer was evaluated.

### (2-1) Manufacturing of Samples for Evaluation, and Evaluation of Mechanical Property of Solidified Sealing Material Layer for a Honeycomb Structure Based on Evaluation of Breaking Strength Using the Sample for Evaluation

### (Manufacturing of Honeycomb Fired Body)

An amount of 52.8% by weight of silicon carbide coarse powders having an average particle diameter of 22 μm and an amount of 22.6% by weight of a silicon carbide fine powder having an average particle diameter of 0.5 μm were mixed. To the resulting mixture, 2.1% by weight of an acrylic resin, 4.6% by weight of an organic binder (methylcellulose), 2.8% by weight of a lubricant (UNILUB, manufactured by NOF Corporation), 1.3% by weight of glycerin, and 13.8% by weight of water were added, and then kneaded to prepare a wet mixture. The obtained wet mixture was extrusion-molded, so that a raw honeycomb molded body having virtually the same shape as the shape shown in FIG. 2A and having cells not plugged was manufactured.

Next, the raw honeycomb molded body was dried by using a microwave drying apparatus to obtain a dried honeycomb molded body. Then, using a plug material paste having the same composition as that of the wet mixture, predetermined cells were filled, and the dried honeycomb molded body in which the plug material paste was filled was again dried by using a drying apparatus.

The dried honeycomb molded body was degreased at 400° C., and then fired at 2200° C. under normal pressure argon atmosphere for three hours, so that a honeycomb fired body including a silicon carbide sintered body, with a porosity of 45%, an average pore diameter of 15 μm, a size of 34.3 mm×34.3 mm×150 mm, the number of cells (cell density) of 300 pcs/inch² and a thickness of the cell wall of 0.25 mm (10 mil), was manufactured.

### (Manufacturing of Samples for Evaluation)

Next, samples for evaluation were manufactured according to the following method.

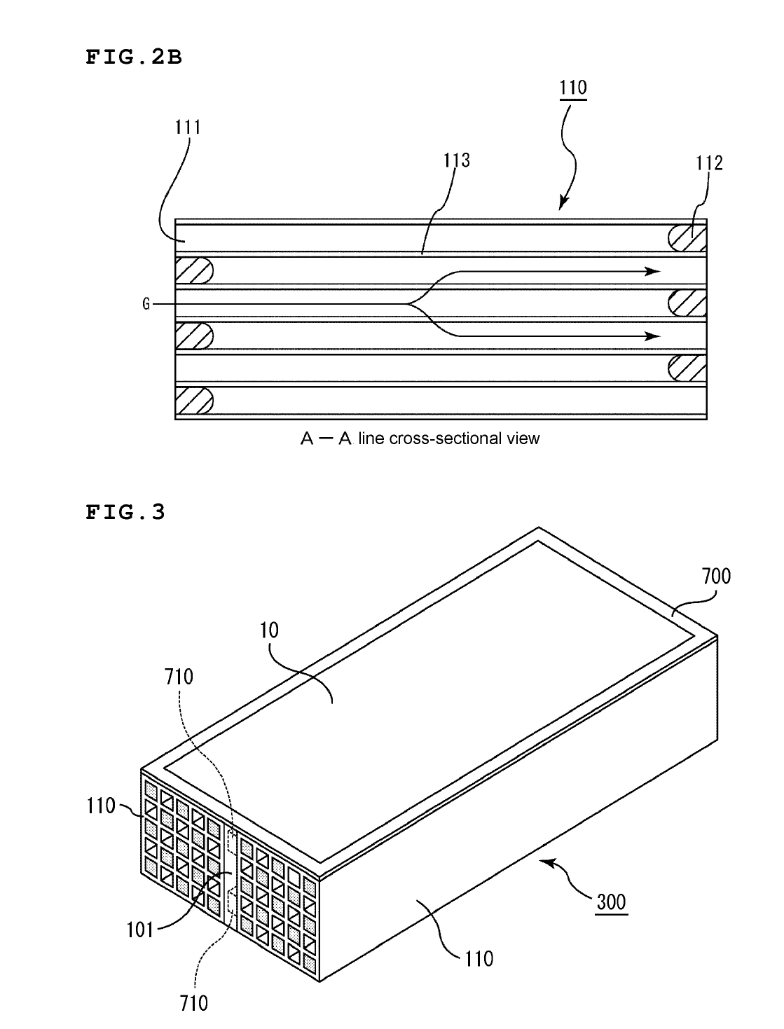

FIG. 3 is a perspective view that schematically shows a method for manufacturing samples for evaluation according to Examples and Comparative Examples.

Each of total four cardboard spacers 710 (thickness: 2.0 mm, Young's modulus: 0.01 GPa) was attached to each of the vicinities of the four corners of a side surface of one of honeycomb fired bodies 110. The spacer 710 was attached to a position where the shortest distances from peripheral portions of the spacer 710 to the two sides forming the corner of the side surface of the honeycomb fired body 110 were both 4.5 mm. Next, the sealing material for a honeycomb structure prepared in Examples and Comparative Examples was applied on the side surface of the honeycomb fired body 110 to which the spacer 710 was attached. Another honeycomb fired body 110 was then bonded to the first honeycomb fired body 110 with the spacer 710 and the sealing material for a honeycomb structure interposed therebetween. Thereafter the two honeycomb fired bodies 110 on which the sealing material for a honeycomb structure was applied were heated at 120° C. to solidify the sealing material for a honeycomb structure so that an adhesive layer 101 having a thickness of 2.0 mm was formed.

Accordingly, a bonded body 300 including the two honeycomb fired bodies 110 and the adhesive layer 101 was manufactured (see FIG. 3).

Next, a peripheral sealing material layer for evaluation was formed on the upper surface of the bonded body 300.

A jig 700 having a rectangular shape with a size of 70.6 mm in width×150 mm in length×0.2 mm in thickness and having an internal rectangular opening is placed on the upper surface of the bonded body 300. The opening was then filled in with a sealing material 10 for a honeycomb structure prepared in Examples and Comparative Examples. The filled sealing material 10 for a honeycomb structure was smoothed using a squeegee so as to match the thickness of the jig 700.

After smoothing the sealing material 10 for a honeycomb structure, the jig 700 was removed. Thereafter, the bonded body 300 was heated at 120° C. in a drying apparatus to solidify the sealing material 10 for a honeycomb structure, thereby forming a peripheral sealing material layer for evaluation.

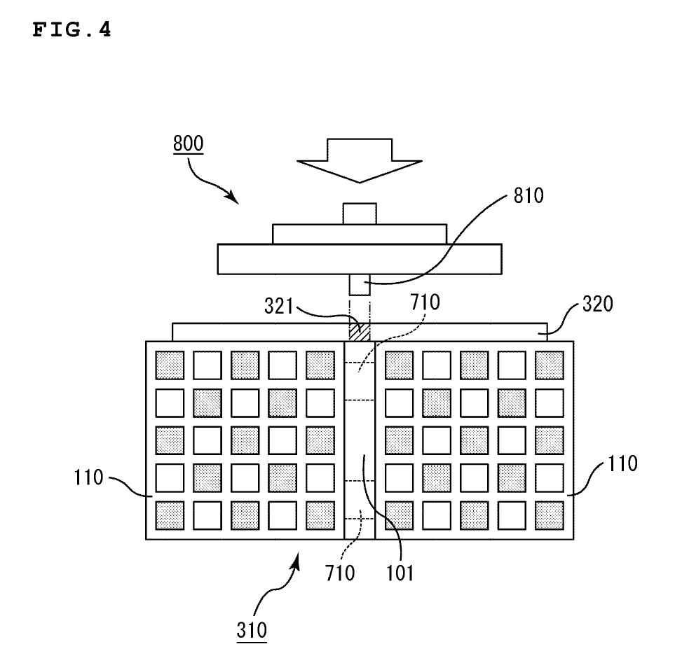

In accordance with the method mentioned earlier, a sample for evaluation including the bonded body 300 as shown in FIG. 3 and the peripheral sealing material layer for evaluation 320 (refer to FIG. 4) (thickness: 0.2 mm) was manufactured. Although FIG. 3 shows the jig 700 used for manufacturing the peripheral sealing material layer for evaluation 320, the jig 700 was removed before the breaking strength measurement.

### (Evaluation of Breaking Strength)

The breaking strength of the peripheral sealing material layer for evaluation was measured for each of the samples for evaluation of Examples and Comparative Examples. The obtained value was used as an index of the bonding strength of the sealing material for a honeycomb structure.

FIG. 4 is a side view that schematically shows a method for measuring the breaking strength of a peripheral sealing material layer for evaluation according to Examples and Comparative Examples.

A compression load was applied to a portion 321 (hereinafter referred to as central portion) which is a portion of the peripheral sealing material layer for evaluation 320, the central portion 321 being located between the two honeycomb fired bodies 110. The load at the time when the central portion 321 was broken was set as the breaking strength. In the measurement of the breaking strength, a texture analyzer 800 and a probe 810 for applying a compression load were used. The probe had a cylindrical pillar shape with a diameter of 1.5 mm and a length of 10 mm.

First, as shown in FIG. 4, the sample 310 for evaluation was placed at a position where a tip of the probe 810 came into contact with the central portion 321 when the probe was moved down. Next, the compression load (MPa) at the time when the probe 810, which was moved down at a speed of 10 mm/s, broke the central portion 321 was set as breaking strength (MPa). Table 1 shows the measurement result of the samples for evaluation.

### (2-2) Manufacturing of Honeycomb Structure, and Evaluation of Coating Property on Sealing Material for a Honeycomb Structure Based on Incidence of Holes in Peripheral Sealing Material Layer Using the Honeycomb Structure

### (Manufacturing of Honeycomb Structure)

On a base having a V-shaped cross section, a honeycomb fired body was placed along the V-shaped cut surface. The sealing material for a honeycomb structure prepared in Examples and Comparative Examples was applied on the honeycomb fired body on its side surface facing upward using a squeegee so that an adhesive paste layer was formed.

On the adhesive paste layer, each of total four spacers (thickness: 1.0 mm) was placed on each of the vicinities of the four corners of the aforementioned side surface.

Each of the four spacers was placed at a position where the shortest distances from peripheral portions of the spacer to the two sides forming the corner of the side surface of the honeycomb fired body were both 4.5 mm.

Thereafter, other honeycomb fired body was placed on the adhesive paste layer and the spacers. The process including applying the sealing material for a honeycomb structure on a side surface of the other honeycomb fired body, placing other spacers, and placing a next honeycomb fired body was repeated so that a honeycomb aggregated body, in which the honeycomb fired bodies were arranged in four columns and four rows, was manufactured.

The thickness (distance between the honeycomb fired bodies) of the adhesive paste layer was controlled to be 1.0 mm.

Further, by heating the honeycomb aggregated body at 120° C., the adhesive paste layer was solidified to be made into an adhesive layer. Accordingly, a ceramic block was manufactured.

The outer periphery of the ceramic block was cut with a diamond cutter into a round pillar shape.

Next, a peripheral sealing material paste layer having a thickness of 0.2 mm was formed on the periphery of the ceramic block using a peripheral sealing material paste which contained the same materials as those of the sealing material for a honeycomb structure.

By drying the peripheral sealing material paste layer at 120° C., a honeycomb structure having a round pillar shape with a diameter of 132.5 mm and a height of 150 mm, in which the peripheral sealing material layer was formed on the periphery of the ceramic block was manufactured.

### (Supporting of Catalyst)

Next, γ-alumina powders and a sufficient amount of water were mixed, and stirred to prepare an alumina slurry. The honeycomb structure, with one of the end faces facing downward, was immersed in the alumina slurry and kept for one minute. Thereafter, drying for drying the honeycomb structure at 110° C. for one hour, and firing for further firing the resulting honeycomb structure at 700° C. for one hour were performed so that a catalyst supporting layer was formed.

Immersing the honeycomb structure in the alumina slurry, drying and firing were repeated until the amount of the formed catalyst supporting layer reached 40 g per liter of the apparent volume of the region where the catalyst supporting layer was formed in the honeycomb structure.

After the formation of the catalyst supporting layer in the honeycomb structure, the honeycomb structure having the catalyst supporting layer formed therein was impregnated, with an end of the gas-inlet side facing downward, in a nitric acid solution of diammine dinitro platinum ([Pt(NH₃)₂(NO₂)₂]HNO₃, platinum concentration: 4% by weight) and kept for one minute. The resulting honeycomb structure was dried at 110° C. for two hours, and then fired at 500° C. for one hour under a nitrogen atmosphere so that a platinum catalyst was supported on the catalyst supporting layer of the honeycomb structure. The amount of the supported catalyst was controlled in a manner that 3 g of platinum was supported per 20 g of alumina as the catalyst supporting layer.

### (Evaluation on Incidence of Holes in Peripheral Sealing Material Layer)

The honeycomb structure prior to canning was evaluated for the incidence of holes in the peripheral sealing material layer using 100 pieces of the honeycomb structures manufactured as mentioned earlier.

Presence of holes or cracks in the peripheral sealing material layer was visually checked for the honeycomb structures prior to the canning. The ratio of the number of the honeycomb structures in which holes or cracks were found in the peripheral sealing material layer with respect to the 100 pieces of the honeycomb structures was determined as an incidence of holes (%) in the peripheral sealing material layer. Table 1 shows the evaluation results of the incidence of holes in peripheral sealing material layer.

Table 1 collectively shows the substances and the metal contents of the metal-containing materials used for preparing the sealing materials for a honeycomb structure as well as the results of the breaking strength and the incidence of holes in the peripheral sealing material layer relating to the sealing materials for a honeycomb structure prepared in Examples 1 to 12 and Comparative Examples 1 to 6.

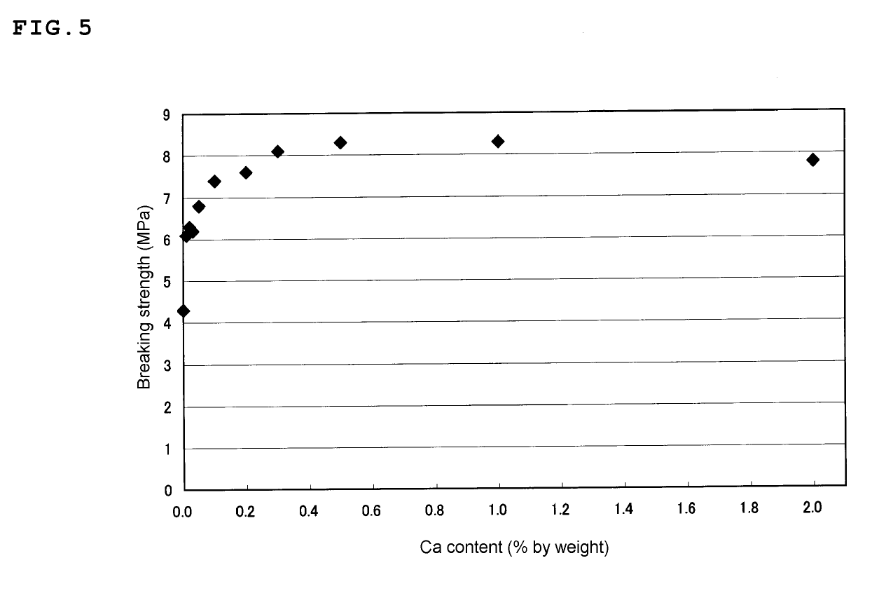

Further, a graph of FIG. 5 shows the relations between the calcium content in the sealing material for a honeycomb structure and the breaking strength based on the results of the measurement of the breaking strength in Examples 1 to 10 and Comparative Example 1.

TABLE 1

| | Metal-containing | | | Result of Evaluation | | |
|---|---|---|---|---|---|---|
| | material | | | Breaking | Incidence of holes in | |
| | | | Content | strength | peripheral sealing material | |
| | Substance | Metal | (wt %) | (MPa) | layer (%) | |
| Example 1 | Calcium carbonate | Ca | 0.03 | 6.2 | 0 | |
| Example 2 | Calcium carbonate | Ca | 0.01 | 6.1 | 0 | |
| Example 3 | Calcium carbonate | Ca | 0.02 | 6.3 | 0 | |
| Example 4 | Calcium carbonate | Ca | 0.05 | 6.8 | 0 | |
| Example 5 | Calcium carbonate | Ca | 0.1 | 7.4 | 0 | |
| Example 6 | Calcium carbonate | Ca | 0.2 | 7.6 | 0 | |
| Example 7 | Calcium carbonate | Ca | 0.3 | 8.1 | 0 | |
| Example 8 | Calcium carbonate | Ca | 0.5 | 8.3 | 0 | |
| Example 9 | Calcium carbonate | Ca | 1.0 | 8.3 | 0 | |
| Example 10 | Calcium carbonate | Ca | 2.0 | 7.8 | 0 | |
| Example 11 | Magnesium | Mg | 0.03 | 6.1 | 0 | |
| | carbonate | | | | | |
| Example 12 | Calcium sulfate | Ca | 0.03 | 6.1 | 0 | |
| Comparative | — | — | 0 | 4.3 | 8 | |
| Example 1 | | | | | | |
| Comparative | Lithium carbonate | Li | 0.03 | 4.2 | 7 | |
| Example 2 | | | | | | |
| Comparative | Sodium carbonate | Na | 0.03 | 4.0 | 9 | |
| Example 3 | | | | | | |
| Comparative | Potassium | K | 0.03 | 4.3 | 8 | |
| Example 4 | carbonate | | | | | |
| Comparative | Copper sulfate | Cu | 0.03 | — | — | (Note) |
| Example 5 | | | | | | |
| Comparative | Aluminum sulfate | Al | 0.03 | — | — | (Note) |
| Example 6 | | | | | | |

(Note) Due to gelation during manufacturing, a sealing material for a honeycomb structure could not be manufactured in Comparative Examples 5 and 6.

The results of the measurement of the breaking strength of the peripheral sealing material layers for evaluation showed that when the calcium content in the sealing material for a honeycomb structure was 0.01% to 1.0% by weight, the breaking strength was as high as 6.1 to 8.3 MPa. Moreover, when the calcium content in the sealing material for a honeycomb structure was 2.0% by weight, the breaking strength was 7.8 MPa and the calcium content in the sealing material for a honeycomb structure was saturated.

In the case where the peripheral sealing material layer for evaluation had a breaking strength of about 6.0 MPa or more, the sealing material layer for a honeycomb structure may be of a level that can be practically used as the peripheral sealing material.

Further, as shown in the graph of FIG. 5, a larger amount of Ca in the sealing material for a honeycomb structure resulted in a higher breaking strength until the calcium content reached saturation point. This indicates that the breaking strength of the peripheral sealing material layer for evaluation depends on the calcium content in the sealing material for a honeycomb structure.

Moreover, in the case where the sealing material for a honeycomb structure was prepared using magnesium carbonate or calcium sulfate in place of the calcium carbonate, the breaking strength was 6.1 MPa in each case. In other words, the breaking strength was similarly about 6.0 MPa or more as in the case of the sealing material for a honeycomb structure prepared using calcium carbonate.

On the other hand, in the case where the calcium content in the sealing material for a honeycomb structure was 0% by weight, the breaking strength was as low as 4.3 MPa.

In the case where the sealing material for a honeycomb structure was prepared using lithium carbonate, sodium carbonate or potassium carbonate in place of the calcium carbonate, the breaking strength was 4.2 MPa, 4.0 MPa, or 4.3 MPa, respectively. Those values were similar with the value in the result of Comparative Example 1 in which no metal-containing material was added. Namely, it is considered that use of the foregoing metal-containing materials did not produce any breaking strength-improving effects of the sealing material.

In the case where the sealing material for a honeycomb structure was prepared using copper sulfate or aluminum sulfate, gelation of the sealing material paste occurred upon manufacturing the sealing material for a honeycomb structure, making it impossible to manufacture a sealing material for a honeycomb structure.

Next, the incidence of holes in the peripheral sealing material layers was evaluated. The results showed that when the calcium content in the sealing material for a honeycomb structure was 0.01% to 1.0% by weight, the incidence of holes was 0% by weight, namely no holes or cracks occurred in the peripheral sealing material layer. Also, in the case where the calcium content in the sealing material layer for a honeycomb structure was 2.0% by weight, no holes or cracks occurred in the peripheral sealing material layer.

Moreover, in the case where the sealing material for a honeycomb structure was prepared using magnesium carbonate or calcium sulfate in place of the calcium carbonate, the incidence of holes in the peripheral sealing material layer was 0%.

On the other hand, in the case where the sealing material for a honeycomb structure contains 0% by weight of Ca or in the case where the sealing material for a honeycomb structure was prepared using lithium carbonate, sodium carbonate or potassium carbonate, the incidence of holes in the peripheral sealing material layer was as high as 7 to 9%.

Accordingly, it is considered that when a metal-containing material that contains Ca or Mg is added to the sealing material for a honeycomb structure, a peripheral sealing material layer for evaluation with excellent breaking strength can be formed. The sealing material for a honeycomb structure of this kind may thus have excellent adhesion strength. Therefore, when the sealing material for a honeycomb structure is used as the peripheral sealing material for a honeycomb structure, damages such as cracks may be prevented from occurring in the peripheral sealing material layer.

In addition to the foregoing metal-containing materials, use of calcium acetate, magnesium nitrate, magnesium sulfate, magnesium acetate, or strontium carbonate may produce similar effects as those achieved in Examples of the present invention.

### Second Embodiment

The following description will discuss a second embodiment that is one of other embodiments of the present invention. In the present embodiment, although the composition of the sealing material for a honeycomb structure and the structure of the honeycomb structure are the same as those in the first embodiment, a different method for forming an adhesive layer is used in the method for manufacturing a honeycomb structure.

First, a plurality of honeycomb fired bodies are placed in parallel with one another in columns and rows, with a spacer interposed therebetween. The spacer is designed to have the same thickness as the thickness of the adhesive layer formed between the honeycomb fired bodies. As a result, a gap corresponding to the thickness of the spacer is formed between the honeycomb fired bodies.

Thereafter, 16 pieces of honeycomb fired bodies are placed in parallel with one another in four columns and four rows to form a parallel-arranged body of honeycomb fired bodies.

Successively, the gap formed between the honeycomb fired bodies placed in parallel with one another is filled in with the sealing material for a honeycomb structure described in the first embodiment by using a filling apparatus.

In filling the gap formed between the honeycomb fired bodies with the sealing material for a honeycomb structure described in the first embodiment, the parallel-arranged body of honeycomb fired bodies is placed inside the inner space of a tubiform, and the sealing material paste supply unit is set up to the end face of the tubiform. Then, the sealing material for a honeycomb structure described in the first embodiment is extruded from a paste chamber of the sealing material paste supply unit by using an extruding mechanism to fill the gap between the honeycomb fired bodies.

Through these processes, a laminated body of the honeycomb fired bodies having the 16 pieces of honeycomb fired bodies with the gap filled with the sealing material for a honeycomb structure as an adhesive is manufactured.

Successively, the laminated body of the honeycomb fired bodies is heated by using a drying apparatus or the like to dry and solidify the adhesive so that an adhesive layer is formed.

Through these processes, a rectangular pillar-shaped ceramic block including 16 pieces of the honeycomb fired bodies can be manufactured.

In forming the peripheral sealing material layer, the same method as that of the first embodiment in which, after peripheral cutting, the sealing material for a honeycomb structure described in the first embodiment is applied to the peripheral surface of the ceramic block by using a squeegee is used.

In addition to the foregoing effects (1) to (6) described in the first embodiment, the present embodiment can produce the following effects.

(8) In the method for manufacturing a honeycomb structure of the present embodiment, when forming the adhesive layer, the gap between the honeycomb fired bodies is filled in with the sealing material for a honeycomb structure described in the first embodiment. Since the sealing material for a honeycomb structure shows almost no decrease in the flowability caused by increase in the viscosity of the sealing material paste even long after the preparation of the sealing material paste, filling of the sealing material for a honeycomb structure as an adhesive tends to be easily performed.

(9) In the method for manufacturing a honeycomb structure according to the present embodiment, when forming the peripheral sealing material layer, the sealing material for a honeycomb structure described in the first embodiment is applied to the peripheral surface of the ceramic block. Since the sealing material for a honeycomb structure shows almost no decrease in the flowability caused by increase in the viscosity of the sealing material paste even long after the preparation of the sealing material paste, it may become easier to prevent deterioration of the processability upon formation of the peripheral sealing material layer.

### Third Embodiment

The following description will discuss a third embodiment that is one of other embodiments of the present invention.

In the present embodiment, the composition of the sealing material for a honeycomb structure and the structure of a honeycomb structure are the same as those of the first embodiment, and the shape of the honeycomb structure is virtually the same as that of the first embodiment. At the same time, honeycomb fired bodies having a different shape from that of the first embodiment are used, and different methods for forming an adhesive layer and a peripheral sealing material layer from those of the first embodiment are employed in the method for manufacturing a honeycomb structure.

In the method for manufacturing a honeycomb structure of the present embodiment, three kinds of honeycomb fired bodies each having a different shape in the cross-section perpendicular to the longitudinal direction thereof are manufactured. The cross-section of a first honeycomb fired body has a shape surrounded by two straight lines and one curve. The cross-section of a second honeycomb fired body has a shape surrounded by three straight lines and one curve. The cross-section of a third honeycomb fired body has a shape surrounded by four straight lines. These three kinds of honeycomb fired bodies having mutually different cross-sectional shapes can be manufactured by altering the shape of a die to be used for extrusion-molding. Those honeycomb fired bodies correspond, for example, to the honeycomb fired bodies having three kinds of shapes configuring the honeycomb structure shown in FIG. 1.

Thereafter, a plurality of these three kinds of honeycomb fired bodies are placed in columns and rows in parallel with one another, with a spacer interposed therebetween, to form a parallel-arranged body of honeycomb fired bodies having a virtually round shape in its cross-section perpendicular to the longitudinal direction.

At this time, a gap having a thickness of the spacer is formed between the respective honeycomb fired bodies.

Successively, the parallel-arranged body of honeycomb fired bodies is placed in a filling device having a cylindrical tubiform, and a gap formed between the honeycomb fired bodies and a gap formed between the honeycomb fired bodies and the tubiform were filled in with a sealing material for a honeycomb structure described in the foregoing first embodiment.

A filling device used in the present embodiment is provided with the cylindrical tubiform and a sealing material paste supply unit. The tubiform has a slightly larger inner diameter than the diameter of the parallel-arranged body of honeycomb fired bodies to be placed in the tubiform. Therefore, when the parallel-arranged body of honeycomb fired bodies is placed in the inner space of the tubiform, a gap is formed between the tubiform and the parallel-arranged body of honeycomb fired bodies.

The sealing material paste supply unit is configured to have a structure which enables simultaneously filling the gap between the honeycomb fired bodies and the gap between the tubiform and the parallel-arranged body of the honeycomb fired bodies with the sealing material for a honeycomb structure described in the foregoing first embodiment, the sealing material stored in the sealing material paste chamber.

In the method for manufacturing a honeycomb structure of the present embodiment, by using the parallel-arranged body of honeycomb fired bodies and the filling apparatus that have been described above, the gap between the honeycomb fired bodies and the gap between the honeycomb fired bodies and the tubiform are filled in with the sealing material for a honeycomb structure described in the foregoing first embodiment. Next, the sealing material for a honeycomb structure is dried and solidified so that the adhesive layer between the honeycomb fired bodies and the peripheral sealing material layer are simultaneously formed.

In addition to the effects (1) to (6) described in the first embodiment, the present embodiment can produce the following effects.

(10) In the method for manufacturing a honeycomb structure of the present embodiment, when forming the adhesive layer and the peripheral sealing material layer, the gap between the honeycomb fired bodies and the gap between the honeycomb fired bodies and the tubiform are filled in with the sealing material for a honeycomb structure described in the first embodiment. Since the sealing material for a honeycomb structure shows almost no decrease in the flowability caused by increase in the viscosity of the sealing material paste even long after the preparation of the sealing material paste, filling of the sealing material for a honeycomb structure as an adhesive and a peripheral sealing material tend to be easily performed. Accordingly, it may become easier to simultaneously and easily form the adhesive layer between the honeycomb fired bodies and the peripheral sealing material layer.

(11) In the method for manufacturing the honeycomb structure of the present embodiment, the parallel-arranged body of honeycomb fired bodies having an almost circular shape in its cross section perpendicular to the longitudinal direction is manufactured by placing in columns and rows a plurality of three kinds of honeycomb fired bodies having different cross-sectional shapes in the longitudinal direction thereof. Accordingly, it may become easier to manufacture a honeycomb structure having a predetermined outer peripheral shape without peripheral cutting.

### Fourth Embodiment

The following description will discuss a fourth embodiment that is still one of other embodiments of the present invention.

In the present embodiment, the composition of the sealing material for a honeycomb structure is the same as that of the first embodiment. At the same time, the shape of the honeycomb structure and the method for manufacturing a honeycomb structure are different from those of the first embodiment.

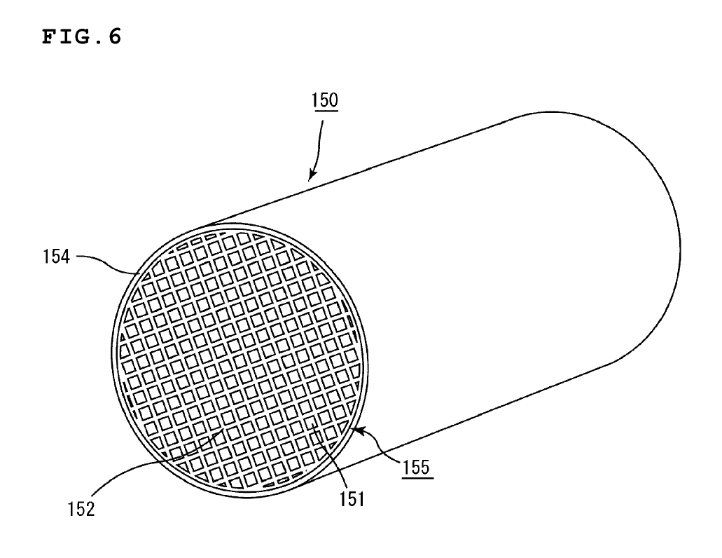

FIG. 6 is a perspective view that schematically shows one of other examples of the honeycomb structure of the embodiment of the present invention.

A honeycomb structure 150 shown in FIG. 6 has a ceramic block 155 including a single piece of a pillar-shaped honeycomb fired body in which a large number of cells 151 are longitudinally placed in parallel with one another with a cell wall 152 therebetween, and a peripheral sealing material layer 154 is formed on the periphery of the ceramic block 155.

In the method for manufacturing a honeycomb structure of the present embodiment, honeycomb fired bodies are manufactured by following the same procedure as in the first embodiment, except that a honeycomb molded body having a virtually cylindrical shape is formed by altering the shape of a die used for extrusion-molding.

This honeycomb fired body is allowed to form a ceramic block without bonding of a plural of honeycomb fired bodies.

Thereafter, forming a peripheral sealing material layer on the peripheral surface of the ceramic block is carried out by using the sealing material for a honeycomb structure of the first embodiment.

When forming peripheral sealing material layer, the same method as that of the first embodiment in which the sealing material for a honeycomb structure is applied to the peripheral surface of the ceramic block by using a squeegee may be used, or the same method as that of the third embodiment in which the gap formed between the peripheral surface of the ceramic block and the tubiform is filled in with the sealing material for a honeycomb structure by using a filling apparatus, may be used.

In this embodiment, the effects (1) to (4) described in the foregoing first embodiment and the effect (9) described in the foregoing second embodiment can be exhibited.

### Other Embodiments

In the honeycomb structure of the embodiment of the present invention, the sealing material for a honeycomb structure used to form the adhesive layer and the sealing material for a honeycomb structure used to form the peripheral sealing material layer may include the same materials or different materials.

Moreover, as the adhesive, other than the sealing material for a honeycomb structure of the embodiment of the present invention, an adhesive paste that has been conventionally used for manufacturing a honeycomb structure may be used.

In the method for preparing the sealing material for a honeycomb structure according to the embodiment of the present invention, an oxide sol which is alkaline may be used in place of the oxide sol which is acidic.

The pH value of the alkaline oxide sol is not particularly limited, and preferably in a range of about 8.5 to about 10.5.

Preferable examples of the alkaline oxide sol include an alkaline silica sol.

The alkaline oxide sol is mixed with an acidic solution to adjust the pH value of the resultant sealing material paste in a range of about 4 to about 6.

The pH value of the acidic solution is not particularly limited, and the pH value is preferably in a range of about 1 to about 3.

Moreover, kinds of the acidic solution are not particular limited, and examples thereof include a water solution of hydrochloric acid, sulfric acid, nitric acid, phosphoric acid, lactic acid, acetic acid, formic acid or the like. A water solution of lactic acid is especially preferable among the above acidic solutions.

Although not particularly limited, the shape of the honeycomb fired bodies is preferably designed to easily bond the honeycomb fired bodies with one another when manufacturing a honeycomb structure. For example, a shape having a substantially square, a substantially rectangular, a substantially hexagonal, a substantially sector shape or the like in its cross-section may be used.

The shape of the honeycomb structure of the present invention is not particularly limited to a round pillar shape, and may be a desired pillar shape such as a substantially cylindroid shape, a pillar shape with a substantially racetrack end face, and a substantially polygonal pillar shape.

Although not particularly limited, the porosity of the honeycomb fired body is preferably from about 35% to about 60%.

When the honeycomb structure manufactured by using the aforementioned honeycomb fired body is used as a filter, the porosity of about 35% or more is less likely to cause clogging in the filter. On the other hand, the porosity of about 60% or less is less likely to cause a reduction in the strength of the honeycomb fired body, resulting in rarely breakage of the filter.

The average pore diameter of the honeycomb fired body is preferably from about 5 μm to about 30 μm.

When the honeycomb structure manufactured by using the aforementioned honeycomb fired body is used as a filter, the average pore diameter of about 5 μm or more is less likely to cause clogging in the filter. On the other hand, the average pore diameter of about 30 μm or less tends not to allow particulates to easily pass through the pores. As a result, the honeycomb fired body is more likely to capture the particulates, which enables functioning as a filter.

The porosity and the pore diameter can be measured through conventionally known methods such as a mercury porosimetry, Archimedes method, and a measuring method using a scanning electronic microscope (SEM).

The cell density in the cross-section perpendicular to the longitudinal direction of the honeycomb fired body is not particularly limited. A preferable lower limit of the cell density is about 31.0 pcs/cm² (about 200 pcs/inch²) and a preferable upper limit thereof is about 93.0 pcs/cm² (about 600 pcs/inch²). A more preferable lower limit of the cell density is about 38.8 pcs/cm² (about 250 pcs/inch²) and a more preferable upper limit thereof is about 77.5 pcs/cm² (about 500 pcs/inch²).

Further, the thickness of the cell walls of the honeycomb fired body is not particularly limited, and preferably from about 0.1 mm to about 0.4 mm.

The main component of constituent materials of the honeycomb fired body is not limited to silicon carbide. Examples of other ceramic materials include ceramic powders, for example, nitride ceramics such as aluminum nitride, silicon nitride, boron nitride and titanium nitride; carbide ceramics such as zirconium carbide, titanium carbide, tantalum carbide and tungsten carbide; oxide ceramics such as alumina, zirconia, cordierite, mullite, and aluminum titanate; and the like.

Non-oxide ceramics are preferable, and silicon carbide is more preferable among the above components, because they are excellent in thermal resistance properties, mechanical strength, thermal conductivity and the like. Moreover, examples of the constituent material of the honeycomb fired body also include silicon-containing ceramics, in which metallic silicon is blended with the foregoing ceramics, as well as a ceramic material such as ceramic in which the forgoing ceramics is bound by silicon or silicate compounds. The ceramics (silicon-containing silicon carbide) in which metallic silicon is blended with the silicon carbide are preferably used.

A silicon-containing silicon carbide ceramic containing about 60% by weight or more of silicon carbide is especially preferable.

The organic binder used when preparing the wet mixture is not particularly limited, and examples thereof include methylcellulose, carboxymethylcellulose, hydroxyethylcellulose, polyethylene glycol, and the like. Methylcellulose is preferable among the above examples. A blending amount of the organic binder is preferably about 1 parts by weight to about 10 parts by weight with respect to 100 parts by weight of ceramic powder.

The plasticizer used when preparing the wet mixture is not particularly limited, and examples thereof include glycerin and the like. The lubricant is not particularly limited, and examples thereof include polyoxyalkylene-based compounds such as polyoxyethylene alkyl ether and polyoxypropylene alkyl ether, and the like. Specific examples of the lubricant include polyoxyethylene monobutyl ether, polyoxypropylene monobutyl ether and the like.

Moreover, the plasticizer and the lubricant may optionally not be contained in the wet mixture.

In addition, a dispersant solution may be used upon preparing a wet mixture, and examples of the dispersant solution include water, an organic solvent such as benzene, alcohol such as methanol and the like.

Moreover, a molding auxiliary may be added to the wet mixture.

The molding auxiliary is not particularly limited, and examples thereof include ethylene glycol, dextrin, fatty acid, fatty acid soap, polyalcohol and the like.

Furthermore, a pore-forming agent such as balloons that are fine hollow spheres including oxide-based ceramics, spherical acrylic particles, graphite and the like may be added to the wet mixture, if necessary.

The balloon is not particularly limited, and examples thereof include alumina balloon, glass micro balloon, shirasu balloon, fly ash balloon (FA balloon), mullite balloon and the like. Alumina balloon is preferable among the above examples.

The plug material paste for plugging the cells is not particularly limited, a plug to be manufactured through the subsequent processes preferably has a porosity of from about 30% to about 75%, and for example, it is possible to use a plug material paste having the same composition as that of the wet mixture of the raw material for honeycomb fired body.

The catalyst to convert and/or purify exhaust gases may be supported on the honeycomb structure, and preferable examples of the catalyst to be supported include noble metals such as platinum, palladium and rhodium. Platinum is more preferable among these. Moreover, an alkali metal such as sodium and potassium, and an alkaline earth metal such as barium may be used as other catalysts. These catalysts may be used alone, or two or more kinds of these may be used in combination.

The above description has only discussed the honeycomb structure (honeycomb filter) in which either one end portion of each of the cells is plugged. However, the honeycomb structure of the embodiment of the present invention does not always need to have an end portion of each cell plugged, and such honeycomb structures may be preferably used as a catalyst supporting carrier.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A sealing material for a honeycomb structure, comprising:
inorganic fibers comprising a biosoluble inorganic compound;
an oxide sol;
inorganic particles; and
a metal-containing material that contains at least one of Mg, Ca, and Sr,
the sealing material being acidic.

2. The sealing material for a honeycomb structure according to claim 1,
wherein
the inorganic compound comprises at least one of an alkali metal compound and an alkaline earth metal compound.

3. The sealing material for a honeycomb structure according to claim 1,
wherein
the metal-containing material comprises at least one of calcium carbonate, calcium acetate, magnesium carbonate, magnesium nitrate, magnesium sulfate, and magnesium acetate.

4. The sealing material for a honeycomb structure according to claim 3,
wherein
the metal-containing material comprises at least one of calcium carbonate and calcium acetate.

5. The sealing material for a honeycomb structure according to claim 4,
wherein
a calcium content in the sealing material for a honeycomb structure is from about 0.01% by weight to about 1.0% by weight.

6. The sealing material for a honeycomb structure according to claim 1,
wherein
a solubility of the inorganic fibers in physiological saline at about 37° C. is about 300 ppm or more.

7. The sealing material for a honeycomb structure according to claim 2,
wherein
the alkali metal compound comprises at least one of sodium oxides, sodium salts, potassium oxides, and potassium salts.

8. The sealing material for a honeycomb structure according to claim 2,
wherein
the alkaline earth metal compound comprises at least one of magnesium oxides, magnesium salts, calcium oxides, calcium salts, barium oxides, and barium salts.

9. The sealing material for a honeycomb structure according to claim 1,
wherein
an amount of silica contained in the inorganic fibers is from about 60% by weight to about 85% by weight.

10. The sealing material for a honeycomb structure according to claim 1,
wherein
an amount of Al₂O₃ contained in the inorganic fibers is about 2% by weight or less.

11. The sealing material for a honeycomb structure according to claim 1,
wherein
an aspect ratio of the inorganic fibers is from about 2 to about 1000.

12. The sealing material for a honeycomb structure according to claim 1,
wherein
an amount of the inorganic fibers is from about 10% by weight to about 70% by weight as a solid content.

13. The sealing material for a honeycomb structure according to claim 1,
wherein
an average fiber length of the inorganic fibers is from about 0.1 μm to about 1000 μm.

14. The sealing material for a honeycomb structure according to claim 1,
wherein
the oxide sol comprises at least one of silica sol, alumina sol, and zirconia sol.

15. The sealing material for a honeycomb structure according to claim 1,
wherein
an amount of the oxide sol is from about 1% by weight to about 30% by weight as a solid content.

16. The sealing material for a honeycomb structure according to claim 1,
wherein
an average particle diameter of the oxide included in the oxide sol is from about 5 nm to about 30 nm.

17. The sealing material for a honeycomb structure according to claim 1,
wherein
the inorganic particles comprise at least one of silicon carbide, silicon nitride, and boron nitride.

18. The sealing material for a honeycomb structure according to claim 1,
wherein
an amount of the inorganic particles is from about 3% by weight to about 80% by weight.

19. The sealing material for a honeycomb structure according to claim 1,
wherein
an average particle diameter of the inorganic particles is from about 0.01 μm to about 100 μm.

20. The sealing material for a honeycomb structure according to claim 1,
wherein
the metal-containing material comprises at least one of salts and complexes which contain at least one of Mg, Ca, and Sr.

21. The sealing material for a honeycomb structure according to claim 20,
wherein
the salts containing at least one of Mg, Ca, and Sr comprise at least one of a carbonate, a nitrate, a sulfate, a phosphate, an acetate, a citrate, and an oxalate of at least one of Mg, Ca, and Sr, and
wherein
the complexes containing at least one of Mg, Ca, and Sr comprise at least one of: an inorganic complex containing at least one of a carbonate ion, a sulfate ion, and a phosphate ion as an inorganic ligand; and an organic complex containing at least one of dicarboxylic acids, diamines, and derivatives thereof as an organic ligand.

22. The sealing material for a honeycomb structure according to claim 1,
wherein
components constituting the sealing material for a honeycomb structure are from about 30% by weight to about 40% by weight of inorganic fibers containing SiO₂, MgO, CaO, and Al₂O₃; from about 15% by weight to about 20% by weight of silica sol; from about 30% by weight to about 40% by weight of silicon carbide particles; and from about 0.01% by weight to about 1% by weight of calcium carbonate.

23. The sealing material for a honeycomb structure according to claim 1,
wherein
the sealing material for a honeycomb structure has a pH value in a range of about 4 to about 6.

24. A honeycomb structure comprising:
a ceramic block comprising a honeycomb fired body in which a large number of cells are longitudinally placed in parallel with one another with a cell wall interposed therebetween; and
a peripheral sealing material layer formed on a peripheral surface of the ceramic block,
wherein
the peripheral sealing material layer is formed by solidifying a sealing material for a honeycomb structure, the sealing material for a honeycomb structure comprising:
inorganic fibers comprising a biosoluble inorganic compound;
an oxide sol;
inorganic particles; and
a metal-containing material that contains at least one of Mg, Ca, and Sr,
the sealing material being acidic.

25. The honeycomb structure according to claim 24,
wherein
the ceramic block comprises:
a plurality of honeycomb fired bodies; and
an adhesive layer formed between side surfaces of the plurality of the honeycomb fired bodies.

26. The honeycomb structure according to claim 25,
wherein
the adhesive layer is formed of a solidified adhesive.

27. The honeycomb structure according to claim 26,
wherein
the adhesive is the sealing material for a honeycomb structure.

28. The honeycomb structure according to claim 24,
wherein
the inorganic compound comprises at least one of an alkali metal compound and an alkaline earth metal compound.

29. The honeycomb structure according to claim 24,
wherein
the metal-containing material comprises at least one of calcium carbonate, calcium acetate, magnesium carbonate, magnesium nitrate, magnesium sulfate, and magnesium acetate.

30. The honeycomb structure according to claim 29,
wherein
the metal-containing material comprises at least one of calcium carbonate and calcium acetate.

31. The honeycomb structure according to claim 30,
wherein
a calcium content in the sealing material for a honeycomb structure is from about 0.01% by weight to about 1.0% by weight.

32. The honeycomb structure according to claim 24,
wherein
a solubility of the inorganic fibers in physiological saline at about 37° C. is about 300 ppm or more.

33. The honeycomb structure according to claim 28,
wherein
the alkali metal compound comprises at least one of sodium oxides, sodium salts, potassium oxides, and potassium salts.

34. The honeycomb structure according to claim 28,
wherein
the alkaline earth metal compound comprises at least one of magnesium oxides, magnesium salts, calcium oxides, calcium salts, barium oxides, and barium salts.

35. The honeycomb structure according to claim 24,
wherein
an amount of silica contained in the inorganic fibers is from about 60% by weight to about 85% by weight.

36. The honeycomb structure according to claim 24,
wherein
an amount of Al₂O₃ contained in the inorganic fibers is about 2% by weight or less.

37. The honeycomb structure according to claim 24,
wherein
an aspect ratio of the inorganic fibers is from about 2 to about 1000.

38. The honeycomb structure according to claim 24,
wherein
an amount of the inorganic fibers is from about 10% by weight to about 70% by weight as a solid content.

39. The honeycomb structure according to claim 24,
wherein
an average fiber length of the inorganic fibers is from about 0.1 μm to about 1000 μm.

40. The honeycomb structure according to claim 24,
wherein
the oxide sol comprises at least one of silica sol, alumina sol, and zirconia sol.

41. The honeycomb structure according to claim 24,
wherein
an amount of the oxide sol is from about 1% by weight to about 30% by weight as a solid content.

42. The honeycomb structure according to claim 24,
wherein
an average particle diameter of the oxide included in the oxide sol is from about 5 nm to about 30 nm.

43. The honeycomb structure according to claim 24,
wherein
the inorganic particles comprise at least one of silicon carbide, silicon nitride, and boron nitride.

44. The honeycomb structure according to claim 24,
wherein
an amount of the inorganic particles is from about 3% by weight to about 80% by weight.

45. The honeycomb structure according to claim 24,
wherein
an average particle diameter of the inorganic particles is from about 0.01 μm to about 100 μm.

46. The honeycomb structure according to claim 24,
wherein
the metal-containing material comprises at least one of salts and complexes which contain at least one of Mg, Ca, and Sr.

47. The honeycomb structure according to claim 46,
wherein
the salts containing at least one of Mg, Ca, and Sr comprise at least one of a carbonate, a nitrate, a sulfate, a phosphate, an acetate, a citrate, and an oxalate of at least one of Mg, Ca, and Sr, and
wherein
the complexes containing at least one of Mg, Ca, and Sr comprise at least one of: an inorganic complex containing at least one of a carbonate ion, a sulfate ion, and a phosphate ion as an inorganic ligand; and an organic complex containing at least one of dicarboxylic acids, diamines, and derivatives thereof as an organic ligand.

48. The honeycomb structure according to claim 24,
wherein
components constituting the sealing material for a honeycomb structure are from about 30% by weight to about 40% by weight of inorganic fibers containing SiO₂, MgO, CaO, and Al₂O₃; from about 15% by weight to about 20% by weight of silica sol; from about 30% by weight to about 40% by weight of silicon carbide particles; and from about 0.01% by weight to about 1% by weight of calcium carbonate.

49. The honeycomb structure according to claim 25,
wherein
a periphery of the honeycomb structure is cut.

50. The honeycomb structure according to claim 25,
wherein
the honeycomb structure comprises three kinds of honeycomb fired bodies each having a different shape in a cross-section perpendicular to the longitudinal direction thereof, and
wherein
the cross-section of a first honeycomb fired body has a shape surrounded by two straight lines and one curve, the cross-section of a second honeycomb fired body has a shape surrounded by three straight lines and one curve, and the cross-section of a third honeycomb fired body has a shape surrounded by four straight lines.

51. The honeycomb structure according to claim 24,
wherein
the honeycomb structure comprises a single piece of honeycomb fired body.

52. A method for manufacturing a honeycomb structure, the honeycomb structure comprising: a ceramic block comprising a honeycomb fired body in which a large number of cells are longitudinally placed in parallel with one another with a cell wall interposed therebetween; and a peripheral sealing material layer formed on a peripheral surface of the ceramic block,
the method comprising:
preparing a sealing material for a honeycomb structure containing inorganic fibers comprising a biosoluble inorganic compound, an oxide sol, inorganic particles, and a metal-containing material that contains at least one of Mg, Ca, and Sr, the sealing material for a honeycomb structure being acidic; and
forming the peripheral sealing material layer by forming a peripheral sealing material paste layer comprising the sealing material for a honeycomb structure on a peripheral surface of the ceramic block and solidifying the peripheral sealing material paste layer.

53. The method for manufacturing a honeycomb structure according to claim 52, further comprising bonding for constructing the ceramic block, the ceramic block comprising a plurality of honeycomb fired bodies which are bonded with one another with an adhesive layer interposed therebetween,
the bonding including:
preparing a honeycomb aggregated body in which a plurality of the honeycomb fired bodies are bonded with one another with an adhesive layer paste interposed therebetween; and
solidifying the adhesive layer paste to form the adhesive layer.

54. The method for manufacturing a honeycomb structure according to claim 53,
wherein
the sealing material for a honeycomb structure is used as the adhesive layer paste.

55. The method for manufacturing a honeycomb structure according to claim 52,
wherein
the inorganic compound comprises at least one of an alkali metal compound and an alkaline earth metal compound.

56. The method for manufacturing a honeycomb structure according to claim 52,
wherein
the metal-containing material comprises at least one of calcium carbonate, calcium acetate, magnesium carbonate, magnesium nitrate, magnesium sulfate, and magnesium acetate.

57. The method for manufacturing a honeycomb structure according to claim 56,
wherein
the metal-containing material comprises at least one of calcium carbonate and calcium acetate.

58. The method for manufacturing a honeycomb structure according to claim 57,
wherein
a calcium content in the sealing material for a honeycomb structure is about 0.01% by weight to about 1.0% by weight.

59. The method for manufacturing a honeycomb structure according to claim 52,
wherein
a solubility of the inorganic fibers in physiological saline at about 37° C. is about 300 ppm or more.

60. The method for manufacturing a honeycomb structure according to claim 55,
wherein
the alkali metal compound comprises at least one of sodium oxides, sodium salts, potassium oxides, and potassium salts.

61. The method for manufacturing a honeycomb structure according to claim 55,
wherein
the alkaline earth metal compound comprises at least one of magnesium oxides, magnesium salts, calcium oxides, calcium salts, barium oxides, and barium salts.

62. The method for manufacturing a honeycomb structure according to claim 52,
wherein
an amount of silica contained in the inorganic fibers is from about 60% by weight to about 85% by weight.

63. The method for manufacturing a honeycomb structure according to claim 52,
wherein
an amount of Al₂O₃ contained in the inorganic fibers is about 2% by weight or less.

64. The method for manufacturing a honeycomb structure according to claim 52,
wherein
an aspect ratio of the inorganic fibers is from about 2 to about 1000.

65. The method for manufacturing a honeycomb structure according to claim 52,
wherein
an amount of the inorganic fibers is from about 10% by weight to about 70% by weight as a solid content.

66. The method for manufacturing a honeycomb structure according to claim 52,
wherein
an average fiber length of the inorganic fibers is from about 0.1 μm to about 1000 μm.

67. The method for manufacturing a honeycomb structure according to claim 52,
wherein
the oxide sol comprises at least one of silica sol, alumina sol, and zirconia sol.

68. The method for manufacturing a honeycomb structure according to claim 52,
wherein
an amount of the oxide sol is from about 1% by weight to about 30% by weight as a solid content.

69. The method for manufacturing a honeycomb structure according to claim 52,
wherein
an average particle diameter of the oxide included in the oxide sol is from about 5 nm to about 30 nm.

70. The method for manufacturing a honeycomb structure according to claim 52,
wherein
the inorganic particles comprise at least one of silicon carbide, silicon nitride, and boron nitride.

71. The method for manufacturing a honeycomb structure according to claim 52,
wherein
an amount of the inorganic particles is from about 3% by weight to about 80% by weight.

72. The method for manufacturing a honeycomb structure according to claim 52,
wherein
an average particle diameter of the inorganic particles is from about 0.01 μm to about 100 μm.

73. The method for manufacturing a honeycomb structure according to claim 52,
wherein
the metal-containing material comprises at least one of salts and complexes which contain at least one of Mg, Ca, and Sr.

74. The method for manufacturing a honeycomb structure according to claim 73,
wherein
the salts containing at least one of Mg, Ca, and Sr comprise at least one of a carbonate, a nitrate, a sulfate, a phosphate, an acetate, a citrate, and an oxalate of at least one of Mg, Ca, and Sr, and
wherein
the complexes containing at least one of Mg, Ca, and Sr comprise at least one of: an inorganic complex containing at least one of a carbonate ion, a sulfate ion, and a phosphate ion as an inorganic ligand; and an organic complex containing at least one of dicarboxylic acids, diamines, and derivatives thereof as an organic ligand.

75. The method for manufacturing a honeycomb structure according to claim 52,
wherein
components constituting the sealing material for a honeycomb structure are from about 30% by weight to about 40% by weight of inorganic fibers containing SiO₂, MgO, CaO, and Al₂O₃; from about 15% by weight to about 20% by weight of silica sol; from about 30% by weight to about 40% by weight of silicon carbide particles; and from about 0.01% by weight to about 1% by weight of calcium carbonate.

76. The method for manufacturing a honeycomb structure according to claim 52,
wherein
the sealing material for a honeycomb structure has a pH value in a range of about 4 to about 6.

77. The method for manufacturing a honeycomb structure according to claim 76,
wherein
an acidic oxide sol is used to adjust the pH value of the sealing material to be in a range of about 4 to about 6.

78. The method for manufacturing a honeycomb structure according to claim 77,
wherein
the oxide sol has a pH value in a range of about 3 to about 6.

79. The method for manufacturing a honeycomb structure according to claim 52,
wherein
an alkaline oxide sol is mixed with an acidic solution to adjust the pH value of the sealing material in a range of about 4 to about 6.

80. The method for manufacturing a honeycomb structure according to claim 79,
wherein
the acidic solution has a pH value in a range of about 1 to about 3.

81. The method for manufacturing a honeycomb structure according to claim 79,
wherein
the acidic solution comprises a water solution of at least one of hydrochloric acid, sulfric acid, nitric acid, phosphoric acid, lactic acid, acetic acid, and formic acid.

82. The method for manufacturing a honeycomb structure according to claim 53, further comprising
cutting a periphery of the ceramic block.

83. The method for manufacturing a honeycomb structure according to claim 53, further comprising,
providing three kinds of honeycomb fired bodies each having a different shape in a cross-section perpendicular to the longitudinal direction thereof, and
wherein
the cross-section of a first honeycomb fired body has a shape surrounded by two straight lines and one curve, the cross-section of a second honeycomb fired body has a shape surrounded by three straight lines and one curve, and the cross-section of a third honeycomb fired body has a shape surrounded by four straight lines.

84. The method for manufacturing a honeycomb structure according to claim 52,
wherein
the honeycomb structure comprises a single piece of honeycomb fired body.

85. The method for manufacturing a honeycomb structure according to claim 53, further comprising,
applying an paste-like adhesive including the sealing material for a honeycomb structure on a predetermined side surface of each of the honeycomb fired bodies to form an adhesive paste layer, and
providing the honeycomb aggregated body in which the plurality of the honeycomb fired bodies are bonded with one another with the adhesive paste layer interposed therebetween.

86. The method for manufacturing a honeycomb structure according to claim 85, further comprising,
heating the honeycomb aggregated body to solidify the adhesive paste layer so that a ceramic block having an adhesive layer is constructed, and
cutting side surfaces of the ceramic block to perform periphery cutting.

87. The method for manufacturing a honeycomb structure according to claim 53, further comprising,
placing a plurality of honeycomb fired bodies in parallel with one another in columns and rows with a spacer interposed therebetween so as to form a parallel-arranged body of honeycomb fired bodies having a gap between the honeycomb fired bodies, and
filling the gap with the sealing material for a honeycomb structure by using a filling apparatus to manufacture a laminated body of the honeycomb fired bodies.

88. The method for manufacturing a honeycomb structure according to claim 87, further comprising,
heating the laminated body of the honeycomb fired bodies to solidify the sealing material for a honeycomb structure so that a ceramic block is manufactured, and
cutting peripheral surfaces of the ceramic block to perform periphery cutting.

89. The method for manufacturing a honeycomb structure according to claim 83, further comprising,
placing the three kinds of honeycomb fired bodies in parallel with one another in columns and rows with a spacer interposed therebetween so as to form a parallel-arranged body of honeycomb fired bodies having a gap between the honeycomb fired bodies,
disposing the parallel-arranged body of honeycomb fired bodies inside a filling apparatus having a tubiform so as to form a gap between the honeycomb fired body and the tubiform,
filling both of the gap between the honeycomb fired bodies and the gap between the honeycomb fired body and the tubiform with the sealing material for a honeycomb structure,
solidifying the sealing material for a honeycomb structure so that the adhesive layer between the honeycomb fired bodies and the peripheral sealing material layer are simultaneously formed.
